(19) United States
(12) Patent Application Publication
(10) Pub. No.: US 2024/0418534 A1
(43) Pub. Date: Dec. 19, 2024

(54) DRIVE ASSIST FORMULATION APPARATUS AND DRIVE ASSIST FORMULATION METHOD

(71) Applicant: Mitsubishi Electric Corporation, Tokyo (JP)

(72) Inventors: Mitsuo SHIMOTANI, Tokyo (JP); Kentaro DAIKOKU, Tokyo (JP); Tomoya IKEUCHI, Tokyo (JP); Yoshiaki ADACHI, Tokyo (JP)

(73) Assignee: Mitsubishi Electric Corporation, Tokyo (JP)

(21) Appl. No.: 18/695,137

(22) PCT Filed: Dec. 27, 2021
(86) PCT No.: PCT/JP2021/048538

§ 371 Date: Mar. 25, 2024

(51) Int. Cl. G01C 21/00

(52) U.S. Cl. CPC G01C 21/387

(57) ABSTRACT

A drive assist formulation apparatus according to the present disclosure includes: a normal-accuracy node information acquisition unit acquiring at least one piece of normal-accuracy node information in a travel route of a subject vehicle calculated using a normal-accuracy map; a high-accuracy map acquisition unit acquiring a high-accuracy map; an association determination unit determining whether or not the normal-accuracy position is associated with the high-accuracy node or the high-accuracy link based on the normal-accuracy node information and association information indicating a correspondence relationship between the normal-accuracy map and the high-accuracy map; a travel determination unit determining whether or not the subject vehicle travels a high-accuracy map road based on a determination result of the association determination unit; and a drive assist formulation unit formulating a drive assist of the subject vehicle using the high-accuracy map when the travel determination unit determines that the subject vehicle travels the high-accuracy map road.

### TECHNICAL FIELD

The present disclosure relates to a drive assist formulation apparatus formulating drive assist for a driver and a drive assist formulation method.

### BACKGROUND ART

Disclosed is a technique including high-accuracy map database (DB) in which a high-accuracy map including road shape information per unit traffic lane is stored to generate drive assist information based the high-accuracy map. The drive assist information is used in a drive assist system of automatic driving or advanced driver-assistance systems (ADAS), for example.

Maintenance of map data currently proceeds in an order of expressways and major roads. However, it is considered that it takes time to also proceed with maintenance of the map data of general roads. In this manner, when the drive assist information is used while the high-accuracy map does not include all of roads, it is important to determine whether a subject vehicle travels a high-accuracy map road included in the high-accuracy map or a normal-accuracy map road which is not included in the high-accuracy map. Herein, the normal-accuracy map road indicates a road included in the normal-accuracy map including the road shape information per unit road.

Considered as a method of determining whether or not the subject vehicle travels the high-accuracy map road included in the high-accuracy map is a method described in Patent Document 1 including a normal-accuracy map DB and a high-accuracy map DB, acquiring a travel track of the subject vehicle using the normal-accuracy map, and determining whether or not the subject vehicle travels the high-accuracy map road based on the acquired travel track.

### PRIOR ART DOCUMENTS

### Patent Document(s)

Patent Document 1: Japanese Patent Application Laid-Open No. 2006-266865

### SUMMARY

### Problem to be Solved by the Invention

However, there is a problem that both the high-accuracy map DB and the normal-accuracy map DB storing the normal-accuracy map at a national level need to be provided to make a determination by the method described above, and a memory capacity of the data increases and cost increases.

In the meanwhile, in-vehicle infotainment (IVI) system which is an in-vehicle information system typified by a car navigation system is widely used. The IVI system includes the normal-accuracy map DB storing the normal-accuracy map at a national level, thus considered is a method of acquiring map information from the IVI system and positional information of the subject vehicle to determine whether the subject vehicle travels the high-accuracy map road or the normal-accuracy map road. Information needs to be checked between the normal-accuracy map DB and the high-accuracy map DB to associate a position of the normal-accuracy map road included in the normal-accuracy map DB in the IVI system with a position of the high-accuracy map road included in the high-accuracy map DB or a position of a traffic lane thereof. However, software of the IVI system needs to be changed to have access to the normal-accuracy map DB included in the IVI system for a purpose of checking the information, thus a problem of increase in cost for developing the IVI system newly arises.

The present disclosure is to solve the above problems, and an object of the present disclosure is to provide a drive assist formulation apparatus and a drive assist formulation method capable of determining whether or not a subject vehicle currently travels a high-accuracy map road from information with a small amount of data while increase in cost for developing an IVI system is suppressed.

### Means to Solve the Problem

In order to solve the above problems, a drive assist formulation apparatus according to the present disclosure includes: a normal-accuracy node information acquisition unit acquiring at least one piece of normal-accuracy node information including normal-accuracy positional information indicating a normal-accuracy position of a normal-accuracy node in a travel route of a subject vehicle calculated using a normal-accuracy map including road shape information and the normal-accuracy node per unit road; a high-accuracy map acquisition unit acquiring a high-accuracy map including road shape information, a high-accuracy node, and a high-accuracy link per unit traffic lane; an association determination unit determining whether or not the normal-accuracy position is associated with the high-accuracy node or the high-accuracy link based on the normal-accuracy node information acquired by the normal-accuracy node information acquisition unit and association information indicating a correspondence relationship between the normal-accuracy map and the high-accuracy map; a travel determination unit determining whether or not the subject vehicle travels a high-accuracy map road included in the high-accuracy map based on a determination result of the association determination unit; and a drive assist formulation unit formulating a drive assist of the subject vehicle using the high-accuracy map when the travel determination unit determines that the subject vehicle travels the high-accuracy map road.

### Effects of the Invention

According to the present disclosure, it is possible to determine whether or not a subject vehicle currently travels a high-accuracy map road from information with a small amount of data while increase in cost for developing an IVI system is suppressed.

These and other objects, features, aspects and advantages of the present disclosure will become more apparent from the following detailed description when taken in conjunction with the accompanying drawings.

### BRIEF DESCRIPTION OF DRAWINGS

FIG. 1 is a block diagram illustrating an example of a configuration of a drive assist formulation apparatus according to an embodiment 1.

FIG. 2 is a block diagram illustrating an example of a configuration of an in-vehicle apparatus including the drive assist formulation apparatus according to the embodiment 1.

FIG. 3 is a flow chart illustrating an example of an operation of the drive assist formulation apparatus according to the embodiment 1.

FIG. 4 is a diagram illustrating an example of a normal-accuracy node on a travel route according to the embodiment 1.

FIG. 5 is a diagram illustrating an example of a high-accuracy node in a high-accuracy map road according to the embodiment 1.

FIG. 6 is a diagram illustrating an example of association information according to the embodiment 1.

FIG. 7 is a diagram illustrating an example of a relationship between the normal-accuracy node and the association positional information according to the embodiment 1.

FIG. 8 is a diagram illustrating an example of the high-accuracy node associated with the normal-accuracy node according to the embodiment 1.

FIG. 9 is a flow chart illustrating an example of an operation of the drive assist formulation apparatus according to an embodiment 2.

FIG. 10 is a diagram illustrating an example of a normal-accuracy node on a travel route according to the embodiment 2.

FIG. 11 is a diagram illustrating an example of association information according to the embodiment 2.

FIG. 12 is a diagram illustrating an example of the high-accuracy node associated with the normal-accuracy node according to the embodiment 2.

FIG. 13 is a diagram illustrating an example of an intermediate node according to the embodiment 2.

FIG. 14 is a diagram illustrating an example of association information according to the embodiment 2.

FIG. 15 is a flow chart illustrating an example of an operation of the drive assist formulation apparatus according to an embodiment 3.

FIG. 16 is a diagram illustrating an example of a normal-accuracy node on a travel route according to the embodiment 3.

FIG. 17 is a diagram illustrating an example of association information according to the embodiment 3.

FIG. 18 is a block diagram illustrating an example of a configuration of an in-vehicle apparatus including a drive assist formulation apparatus according to an embodiment 4.

FIG. 19 is a flow chart illustrating an example of an operation of the drive assist formulation apparatus according to the embodiment 4.

FIG. 20 is a diagram illustrating an example of a high-accuracy node access data record according to the embodiment 4.

FIG. 21 is a diagram illustrating an example of a high-accuracy node data record according to the embodiment 4.

FIG. 22 is a diagram illustrating an example of a high-accuracy node associated with a normal-accuracy node according to the embodiment 4.

FIG. 23 is a diagram illustrating an example of the high-accuracy node associated with the normal-accuracy node according to the embodiment 4.

FIG. 24 is a diagram illustrating an example of the high-accuracy node associated with the normal-accuracy node according to the embodiment 4.

FIG. 25 is a diagram illustrating an example of the high-accuracy node associated with the normal-accuracy node according to the embodiment 4.

FIG. 26 is a diagram illustrating an example of the high-accuracy node associated with the normal-accuracy node according to the embodiment 4.

FIG. 27 is a diagram illustrating an example of the high-accuracy node associated with the normal-accuracy node according to the embodiment 4.

FIG. 28 is a diagram illustrating an example of the high-accuracy node associated with the normal-accuracy node according to the embodiment 4.

FIG. 29 is a diagram illustrating an example of the high-accuracy node associated with the normal-accuracy node according to the embodiment 4.

FIG. 30 is a diagram illustrating an example of the high-accuracy node associated with the normal-accuracy node according to the embodiment 4.

FIG. 31 is a diagram illustrating an example of a high-accuracy link access data record according to an embodiment 5.

FIG. 32 is a diagram illustrating an example of a high-accuracy link data record according to the embodiment 5.

FIG. 33 is a block diagram illustrating an example of a configuration of an in-vehicle apparatus including a drive assist formulation apparatus according to an embodiment 6.

FIG. 34 is a diagram illustrating an example of a hardware configuration of the drive assist formulation apparatus according to the embodiments 1 to 6.

FIG. 35 is a diagram illustrating an example of a hardware configuration of the drive assist formulation apparatus according to the embodiments 1 to 6.

### DESCRIPTION OF EMBODIMENT(S)

### Embodiment 1

### <Configuration>

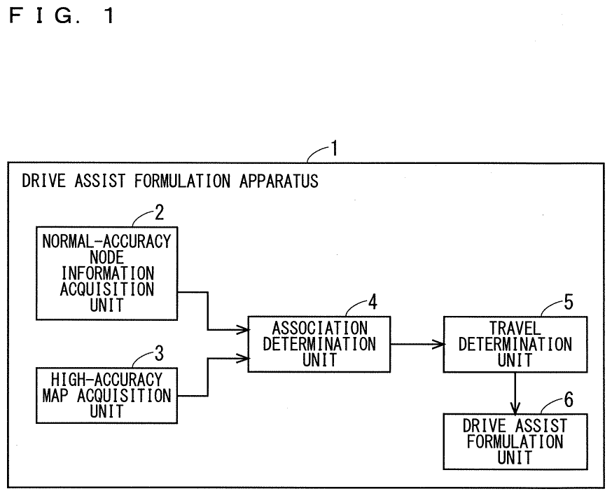

FIG. 1 is a block diagram illustrating an example of a configuration of a drive assist formulation apparatus 1 according to an embodiment 1. FIG. 1 illustrates a bare minimum of configuration constituting the drive assist formation apparatus according to the embodiment 1.

A drive assist formulation apparatus 1 includes a normal-accuracy node information acquisition unit 2, a high-accuracy map acquisition unit 3, an association determination unit 4, a travel determination unit 5, and a drive assist formulation unit 6. The drive assist formulation apparatus 1 is mounted to a vehicle (also referred to as “subject vehicle” hereinafter).

The normal-accuracy node information acquisition unit 2 acquires normal-accuracy node information including normal-accuracy positional information indicating a normal-accuracy position of a normal-accuracy node in a travel route of a subject vehicle calculated using a normal-accuracy map including road shape information and the normal-accuracy node per unit road.

The high-accuracy map acquisition unit 3 acquires a high-accuracy map including road shape information, a high-accuracy node, and a high-accuracy link per unit traffic lane.

The association determination unit 4 determines whether or not the normal-accuracy position is associated to the high-accuracy node or the high-accuracy link based on the normal-accuracy node information acquired by the normal-accuracy node information acquisition unit 2 and association information indicating a correspondence relationship between the normal-accuracy map and the high-accuracy map.

The travel determination unit 5 determines whether or not the subject vehicle travels the high-accuracy map road included in the high-accuracy map based on a determination result of the association determination unit 4.

The drive assist formulation unit 6 formulates a drive assist of the subject vehicle using the high-accuracy map when the travel determination unit 5 determines that the subject vehicle travels the high-accuracy map road.

Described next is the other configuration of a drive assist formulation apparatus including the drive assist formulation apparatus 1 illustrated in FIG. 1.

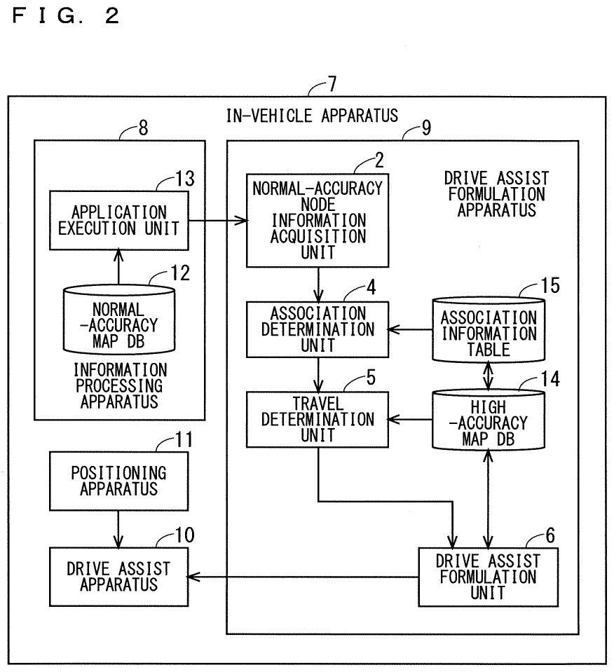

FIG. 2 is a block diagram illustrating an example of a configuration of an in-vehicle apparatus 7 including a drive assist formulation apparatus 9 according to the other configuration.

The in-vehicle apparatus 7 includes an information processing apparatus 8, the drive assist formulation apparatus 9, a drive assist apparatus 10, and a positioning apparatus 11. The in-vehicle apparatus 7 is mounted to a vehicle.

The drive assist formulation apparatus 9 can be applied not only to the in-vehicle apparatus 7 but also a portable navigation device (PND) which can be mounted to a vehicle and an apparatus built as a system by appropriately combining a server etc. provided outside the vehicle. In this case, each function or each constituent element of the drive assist formulation apparatus 9 is separately disposed in each function constituting the system described above.

FIG. 2 illustrates a case where the information processing apparatus 8, the drive assist formulation apparatus 9, the drive assist apparatus 10, and the positioning apparatus 11 are separately provided, however, each apparatus may be optionally combined to constitute an integral apparatus. For example, the drive assist formulation apparatus 9 and the drive assist apparatus 10 may be integrally formed.

The information processing apparatus 8 corresponds to the IVI system described above, and is a navigation apparatus, for example. The information processing apparatus 8 includes a normal-accuracy map DB 12 and an application execution unit 13. The information processing apparatus 8 may be provided outside the subject vehicle.

The normal-accuracy map DB 12 is a storage medium such as a memory or a hard disk drive (HDD), and stores the normal-accuracy map including the road shape information per unit road. The normal-accuracy map includes the normal-accuracy node and a normal-accuracy link expressing at least a road.

The application execution unit 13 executes a navigation function, for example. The application execution unit 13 outputs the normal-accuracy node information along a travel route acquired by a result of a travel route search or a travel route predication to the drive assist formulation apparatus 9. The normal-accuracy node information includes normal accuracy positional information indicating a position of the normal-accuracy node (normal accuracy position) along the travel route. The application execution unit 13 performs the travel route search or the travel route predication using a subject vehicle position positioned by a positioning unit which is included in the information processing apparatus 8 but is not shown the diagrams or a subject vehicle position positioned by the positioning apparatus 11.

The drive assist formulation apparatus 9 includes the normal-accuracy node information acquisition unit 2, the association determination unit 4, the travel determination unit 5, the drive assist formulation unit 6, a high-accuracy map DB 14, and an association information table 15.

The normal-accuracy node information acquisition unit 2 acquires the normal-accuracy node information from the information processing apparatus 8.

The high-accuracy map DB 14 is a storage medium such as a memory or a hard disk drive (HDD), and stores the high-accuracy map including the road shape information per unit traffic lane. The high-accuracy map includes the high-accuracy node and a high-accuracy link expressing at least a road per unit traffic lane. The drive assist formulation apparatus 9 includes the high-accuracy map DB 14, but may include the high-accuracy map acquisition unit 3 illustrated in FIG. 1 in place of the high-accuracy map DB 14. In this case, the high-accuracy map DB 14 may be included in the in-vehicle apparatus 7 separately from the drive assist formulation apparatus 9, and may also be provided outside the subject vehicle.

The association information table 15 is a storage medium such as a memory or a hard disk drive (HDD), and stores association information indicating a correspondence relationship between the normal-accuracy map and the high-accuracy map. The association information table 15 may be provided outside the subject vehicle. Details of the association information is described hereinafter.

The association determination unit 4 determines whether or not the normal-accuracy node included in the normal-accuracy node information is associated with the high-accuracy node or the high-accuracy link stored in the high-accuracy map DB 14 based on the normal-accuracy node information acquired by the normal-accuracy node information acquisition unit 2 and the association information stored in the association information table 15 to specify the high-accuracy node or the high-accuracy link associated with the normal-accuracy node.

The travel determination unit 5 determines whether or not the subject vehicle travels the high-accuracy map road based on a determination result of the association determination unit 4.

The drive assist formulation unit 6 formulates a drive assist for a driver of the subject vehicle using the high-accuracy map stored in the high-accuracy map DB 14 when the travel determination unit 5 determines that the subject vehicle travels the high-accuracy map road. The drive assist formulation unit 6 outputs information regarding the formulated drive assist (drive assist information) to the drive assist apparatus 10.

The positioning apparatus 11 positions a current position of the subject vehicle using a global navigation satellite system (GNSS). The positioning apparatus 11 may position the current position of the subject vehicle also in consideration of a gyro sensor and a vehicle speed sensor, for example, which are provided to the subject vehicle but are not shown in the diagrams.

The drive assist apparatus 10 executes the drive assist for the driver of the subject vehicle based on the drive assist information acquired from the drive assist formulation apparatus 9. Examples of the drive assist include automatic driving, ADAS, and annunciation assist.

### <Operation>

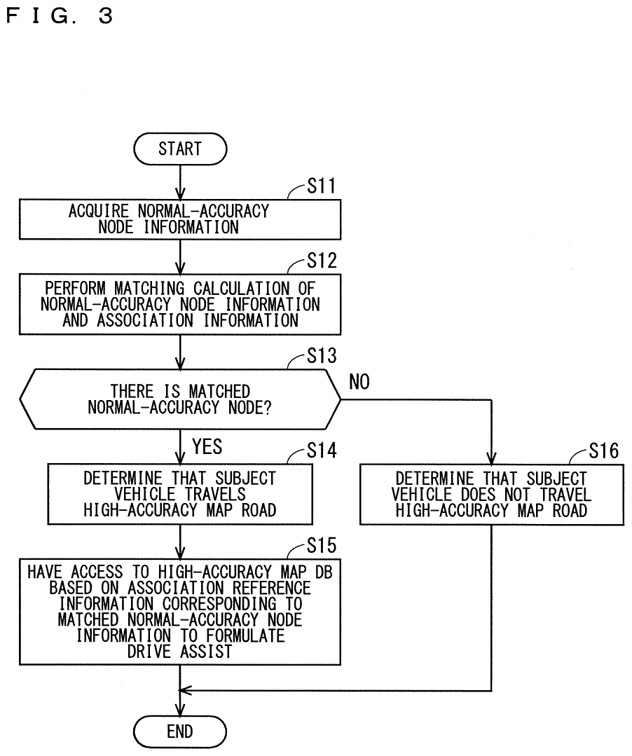

FIG. 3 is a flow chart illustrating an example of an operation of the drive assist formulation apparatus. As a premise of the operation illustrated in FIG. 3, the application execution unit 13 in the information processing apparatus 8 executes the route search or a route predication using the normal-accuracy map stored in the normal-accuracy map DB 12 to generate the normal-accuracy node information in a predetermined range in the travel route of the subject vehicle. The information processing apparatus 8 may output the normal-accuracy node information only once after the application execution unit 13 executes the route search or the route predication, or may also output the normal-accuracy node information several times.

In Step S11, the normal-accuracy node information acquisition unit 2 acquires one or plural pieces of normal-accuracy node information on the travel route of the subject vehicle from the information processing apparatus 8. It is also applicable that the normal-accuracy node information acquisition unit 2 acquires the normal-accuracy node information when the information processing apparatus 8 outputs the normal-accuracy node information only once, and acquires the normal-accuracy node information only a first time when the information processing apparatus 8 outputs the normal-accuracy node information several times.

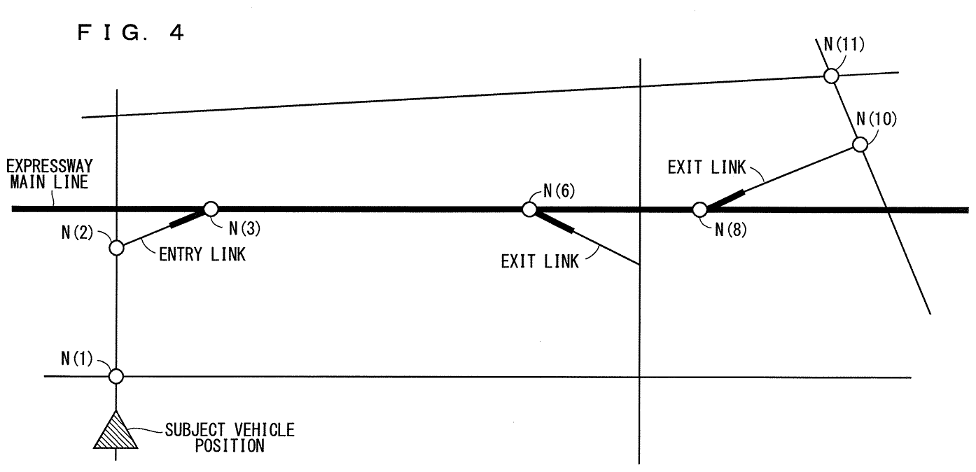

FIG. 4 is a diagram illustrating an example of the normal-accuracy node on the travel route. The normal-accuracy node information acquired by the normal-accuracy node information acquisition unit 2 includes node information in a point where a road enters or exits in the travel route of the subject vehicle. That is to say, the normal-accuracy node includes an entry node connected to the normal-accuracy link in which the other road enters and an exit node connected to the normal-accuracy link in which the road exits from the other road.

In FIG. 4, each of N(1), N(2), N(3), N(6), N(8), N(10), and N(11) is the normal-accuracy node on the travel route of the subject vehicle, and indicates the position in the normal-accuracy map of the normal-accuracy node. The subject vehicle travels in an order of N(1), N(2), N(3), N(6), N(8), N(10), and N(11). The normal-accuracy node information includes the normal-accuracy positional information (coordinate value) of each normal-accuracy node.

A road shown by a thick line in FIG. 4 corresponds to the high-accuracy map road included in the high-accuracy map. That is to say, both the normal-accuracy map and the high-accuracy map include an expressway main line illustrated in FIG. 4. The normal-accuracy node N(3) is connected to an entry link entering the high-accuracy map road. The normal-accuracy nodes N(6) and N(8) are connected to an exit link exiting from the high-accuracy map road.

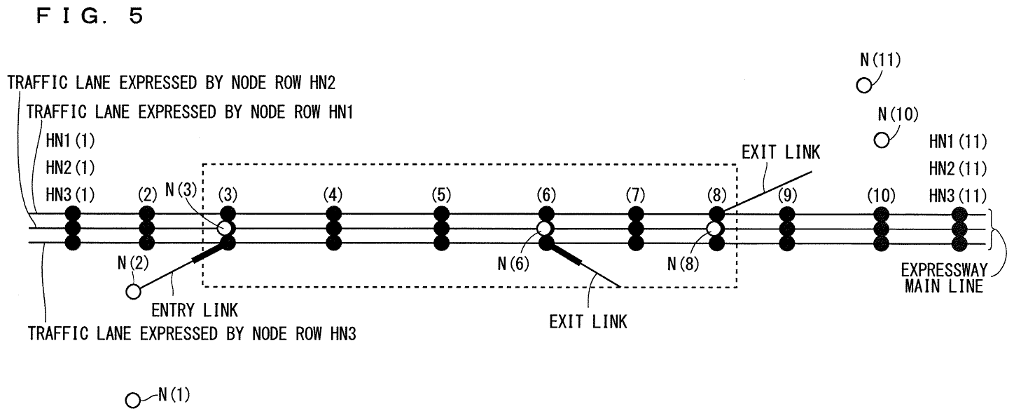

FIG. 5 is a diagram illustrating an example of the high-accuracy node in the high-accuracy map road. FIG. 5 illustrates only a road in one side direction for convenience of description. FIG. 5 also illustrates the normal-accuracy nodes N(1), N(2), N(3), N(6), N(8), N(10), and N(11) illustrated in FIG. 4.

As illustrated in FIG. 5, the high-accuracy map road (expressway main line) includes three traffic lanes (upper traffic lane, middle traffic lane, and lower traffic lane in FIG. 5). Each traffic lane is made up of a high-accuracy node row or a high-accuracy link row connecting the high-accuracy nodes.

The high-accuracy node row of the traffic lane (upper traffic lane) expressed by a node row HN 1 is HN 1(1), HN 1(2), . . . , and HN 1(N1).

The high-accuracy node row of the traffic lane (middle traffic lane) expressed by a node row HN 2 is HN 2(1), HN 2(2), . . . , and HN 2(N2).

The high-accuracy node row of the traffic lane (lower traffic lane) expressed by a node row HN 3 is HN 3(1), HN 3(2), . . . , and HN 3(N3).

In FIG. 5, HN 1(n), HN 2(n), and HN 3(n) are shown to be arranged in tandem, but may not be necessarily arranged in such a form.

The high-accuracy node HN 3(3) is connected to the entry link. The high-accuracy map includes a part of the entry link (refer to FIG. 4).

A range surrounded by a broken line in FIG. 5 indicates a range of the high-accuracy map road which the subject vehicle travels. As illustrated in FIG. 5, the normal-accuracy node N (3) corresponds to the high-accuracy nodes HN 1(3), HN 2(3), and HN 3(3), and the normal-accuracy node N (8) corresponds to the high-accuracy nodes HN 1(8), HN 2(8), and HN 3(8). Accordingly, the range of the high-accuracy nodes HN 1(3), HN 2(3), and HN 3(3) to HN 1(8), HN 2(8), and HN 3(8) corresponding to the normal-accuracy nodes N (3) to N (8) serves as the range of the high-accuracy map road which the subject vehicle travels.

In Step S12, the association determination unit 4 determines whether or not the normal-accuracy node included in the normal-accuracy node information is associated with the high-accuracy node or the high-accuracy link stored in the high-accuracy map DB 14 based on the normal-accuracy node information acquired by the normal-accuracy node information acquisition unit 2 and the association information stored in the association information table 15 to specify the high-accuracy node or the high-accuracy link associated with the normal-accuracy node.

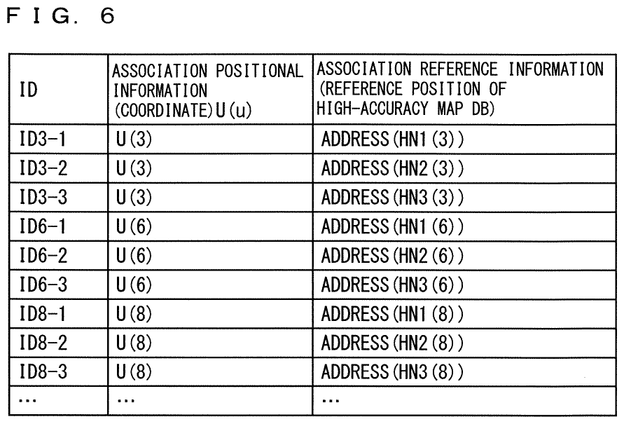

FIG. 6 is a diagram illustrating an example of the association information stored in the association information table 15. As illustrated in FIG. 6, the association information includes an ID, association positional information, and association reference information.

The association positional information is information indicating a representative position including the entry link or the exit link in the high-accuracy map road. That is to say, the association information indicates a position corresponding to a position of a specific high-accuracy node or a position of a specific high-accuracy link. FIG. 6 illustrates the example of positional information U(3), U(6), and U(8) corresponding to the normal-accuracy nodes N(3), N(6), and N(8). For example, the positional information U(3) is a point of intersection between a center line of a road connecting the normal-accuracy nodes N(2) and N(3) and a center line of a traffic lane expressed by the high-accuracy node HN3. Although depending on a creation rule of the high-accuracy map, the positional information U(3) generally coincides with the high-accuracy node HN3(3).

The association reference information is information indicating a reference position of the high-accuracy map DB 14 for having access to the high-accuracy node or the high-accuracy link corresponding to the association positional information. That is to say, the association reference information is information for referring to the high-accuracy node or the high-accuracy link included in the high-accuracy map based on the association positional information. The reference position may be expressed by a uniform resource locator (URL), for example.

The association determination unit 4 performs a matching calculation for determining whether or not each position of the normal-accuracy nodes N(1), N(2), N(3), N(6), N(8), N(10), and N(11) matches the association positional information. For example, the association determination unit 4 determines that the matching is established when a distance from the position of each normal-accuracy node and the position indicated by the association positional information is equal to or smaller than a predetermined threshold value DISth, and determines that the matching is not established when the distance is larger than the predetermined threshold value DISth. That is to say, the association determination unit 4 determines that the matching is established when a distance Dis {N(n), U(u)}≤DISth is satisfied, and determines that the matching is not established when the distance Dis {N(n), U(u)}>DISth is satisfied. Herein, DISth is 20 m, for example.

In the example in FIG. 3, it is determined that the normal-accuracy nodes N(1), N(2), N(10), and N(11) are away from the position indicated by the association positional information, thus the matching is not established.

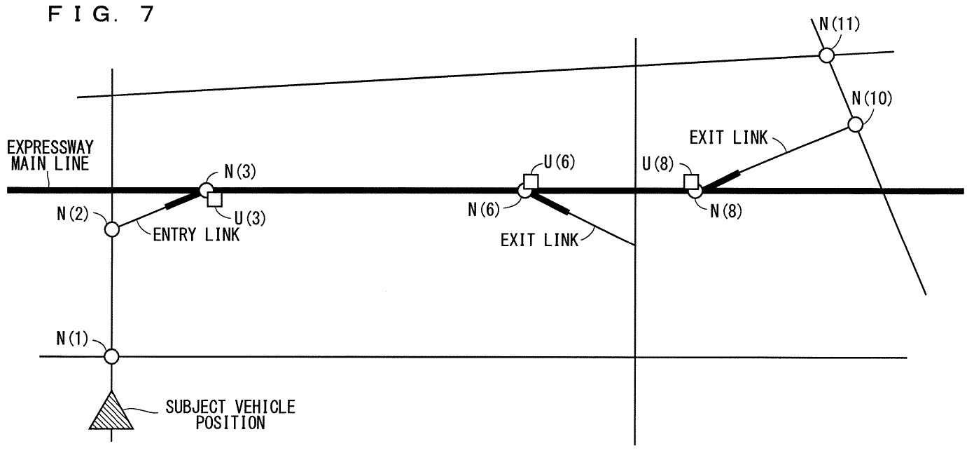

FIG. 7 is a diagram illustrating an example of a relationship between the normal-accuracy node and the association positional information, and the association positional information is overlapped with the normal-accuracy map. In FIG. 7, U3, U6, and U8 indicate the association positional information.

In Step S13, the association determination unit 4 determines whether or not there is a normal-accuracy node matching the association positional information. When there is a normal-accuracy node matching the association positional information, the process proceeds to Step S14. In the meanwhile, when there is no normal-accuracy node matching the association positional information, the process proceeds to Step S16. In the example in FIGS. 4 to 7, the normal-accuracy node N(3) matches the association positional information U(3), the normal-accuracy node N(6) matches the association positional information U(6), and the normal-accuracy node N(8) matches the association positional information U(8). The association positional information U(3) matching the normal-accuracy node N(3) corresponds to an ID 3-1, an ID 3-2, and an ID 3-3. That is to say, the high-accuracy nodes HN 1(3), HN 2(3), and HN 3(3) are candidates for association targets of the normal-accuracy node N(3). The same applies to the normal-accuracy nodes N(6) and N(8).

In Step S14, the travel determination unit 5 determines that the subject vehicle travels the high-accuracy map road.

In Step S15, the drive assist formulation unit 6 has access to the high-accuracy map DB 14 based on the association reference information corresponding to the matched normal-accuracy node information to acquire the high-accuracy node associated with the normal-accuracy node. At this time, the drive assist formulation unit 6 acquires the association reference information corresponding to the matched normal-accuracy node information directly from the association determination unit 4 or via the travel determination unit 5. Then, the drive assist formulation unit 6 formulates the drive assist using the acquired high-accuracy node.

In the example in FIGS. 4 to 7, the drive assist formulation unit 6 can have access to the high-accuracy nodes HN 1(3), HN 2(3), and HN 3(3) based on the association reference information corresponding to each of the matched ID 3-1, ID 3-2, and ID 3-3. The same applies to the ID 6-i and ID 8-i.

According to the processing described above, the drive assist formulation unit 6 determines that the subject vehicle can travel the high-accuracy nodes HN1(3), HN2(3), HN3(3), HN1(6), HN2(6), HN3(6), HN1(8), HN2(8), and HN3(8) in the high-accuracy map road.

Next, the drive assist formulation unit 6 can eliminate the high-accuracy nodes HN1(3) and HN2(3) which are not connected to the entry link and the high-accuracy nodes HN2(8) and HN3(8) which are not connected to the exit link from the candidate of the high-accuracy node which the subject vehicle travels by reason that the subject vehicle passes through the normal-accuracy node N(3) from a road other than the high-accuracy map road to enter the high-accuracy map road, and passes through the normal-accuracy node N(8) to exit from the high-accuracy map road.

Accordingly, the drive assist formulation unit 6 determines that the candidate of the high-accuracy node which the subject vehicle travels is HN3(3), HN1(6), HN2(6), HN3(6), and HN1(8).

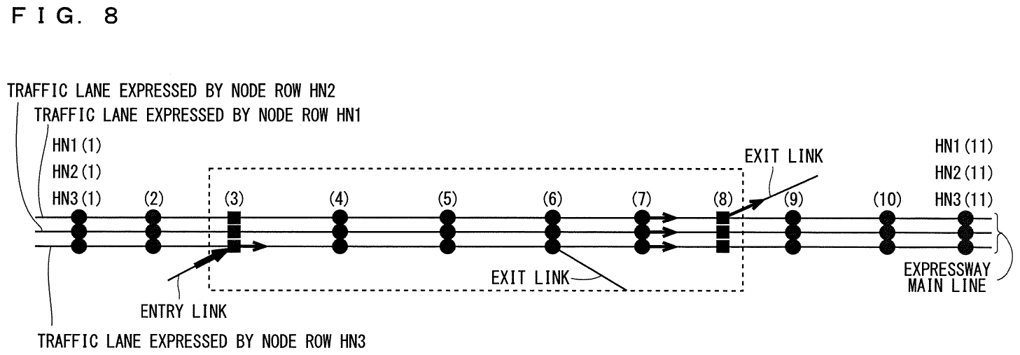

FIG. 8 is a diagram illustrating an example of the high-accuracy node associated with the normal-accuracy node. An arrow in FIG. 8 indicates a traffic lane which the subject vehicle can travel in the high-accuracy map road. A range surrounded by a broken line in FIG. 8 indicates a range of the high-accuracy map road which the subject vehicle travels.

The drive assist formulation unit 6 formulates the drive assist using the high-accuracy node or the high-accuracy link connecting the high-accuracy node. Specifically, the drive assist formulation unit 6 formulates the travel route per unit traffic lane which the subject vehicle the travels using the high-accuracy map including the high-accuracy node or the high-accuracy link associated with the normal-accuracy position of the normal-accuracy node. For example, the drive assist formulation unit 6 formulates the drive assist by performing the route search per unit traffic lane.

Subsequently, the drive assist formulation unit 6 outputs the drive assist information to the drive assist apparatus 10. The drive assist apparatus 10 executes the drive assist such as travel control of the subject vehicle or annunciation of guidance information to the driver based on the drive assist information acquired from the drive assist formulation unit 6 and the subject vehicle position acquired from the positioning apparatus 11.

In Step S16, the travel determination unit 5 determines that the subject vehicle does not travel the high-accuracy map road.

According to the processing described above, it is possible to determine whether or not a subject vehicle currently travels the high-accuracy map road from information with a small amount of data while increase in cost for developing the information processing apparatus 8 (IVI system) is suppressed.

### Modification Example 1

The embodiment 1 describes the case where the association positional information is a point coordinate, however, the configuration is not limited thereto. The association positional information may be expressed in a specific area.

For example, the association positional information may be an area of a circle with a radius of 10 m centering on the position indicated by the association positional information illustrated in FIG. 6, or may also be a section of 20 m square expressed by latitude and longitude. When the association positional information is expressed by the specific area, the association determination unit 4 determines that the matching is established when the normal-accuracy position of the normal-accuracy node is located in a range of the specific area indicated by the association positional information.

### Modification Example 2

The embodiment 1 describes the case where the association reference information is information having access to the high-accuracy node, however, the configuration is not limited thereto. The association reference information may be information having access to the high-accuracy link connected to the high-accuracy node.

### Modification Example 3

The embodiment 1 describes the case where the normal-accuracy node information acquisition unit 2 acquires the normal-accuracy node information when the information processing apparatus 8 outputs the normal-accuracy node information only once, and acquires the normal-accuracy node information only a first time when the information processing apparatus 8 outputs the normal-accuracy node information several times, however, the configuration is not limited thereto. The normal-accuracy node information acquisition unit 2 may acquire the normal-accuracy node information several times.

For example, when the information processing apparatus 8 outputs the normal-accuracy node information every time the information processing apparatus 8 searches the route again, it is applicable that the normal-accuracy node information acquisition unit 2 acquires the normal-accuracy node information every time the information processing apparatus 8 outputs the normal-accuracy node information, and the association determination unit 4 performs matching every time then.

### Modification Example 4

It is applicable that the information processing apparatus 8 outputs the normal-accuracy node information at predetermined time intervals or for each event, and the drive assist formulation apparatus 9 executes the matching processing and the drive assist formulation processing. That is to say, the normal-accuracy node information acquisition unit 2 repetitively acquires the normal-accuracy node information at a predetermined timing. Herein, the predetermined time interval is ten minutes, for example. The matching processing is synonymous with the matching calculation described above.

### Modification Example 5

It is applicable that the normal-accuracy node information outputted from the information processing apparatus 8 is not the whole travel route but is a range of 500 m in back of the subject vehicle position and 2 km in front thereof. That is to say, the information processing apparatus 8 outputs each normal-accuracy node information in a predetermined range based on the subject vehicle as a base point. The normal-accuracy node information acquisition unit 2 of the drive assist formulation apparatus 9 acquires each normal-accuracy node information in a predetermined range based on the subject vehicle as the base point.

It is applicable that the drive assist formulation apparatus 9 does not perform matching processing on all pieces of normal-accuracy node information acquired from the information processing apparatus 8 but performs matching processing using only the normal-accuracy node information in a constant range from the subject vehicle position. In this manner, the normal-accuracy node information used in performing calculation in the drive assist formulation apparatus 9 may be limited. Herein, the subject vehicle position may be acquired from the information processing apparatus 8 or the other apparatus. When the subject vehicle position is acquired from the information processing apparatus 8, the information processing apparatus 8 includes a positioning unit not shown in the diagrams. When the subject vehicle position is acquired from the other apparatus, examples of the other apparatus include a smartphone, a driver recorder, or an event recorder.

When a range of the normal-accuracy node on which the matching processing is performed at a time of acquiring the normal-accuracy node information for a first time after the subject vehicle starts traveling is a first matching range and a range of the normal-accuracy node on which the matching processing is performed at a time of acquiring the normal-accuracy node information subsequently is a second matching range, the second matching range may be larger than the first matching range. A result of previous matching processing can be diverted for second and subsequent times, thus the matching processing can be performed even on the normal-accuracy node information at a long distance.

The information processing apparatus 8 may change a range of the first normal-accuracy node information and a range of the subsequent the normal-accuracy node information. In this case, the drive assist formulation apparatus 9 may perform the matching processing on all pieces of normal-accuracy node information acquired from the information processing apparatus 8.

Described above is the case where the normal-accuracy node information acquisition unit 2 acquires each normal-accuracy node information in the predetermined range based on the subject vehicle as the base point, however, the configuration is not limited thereto. It is sufficient that the normal-accuracy node information acquisition unit 2 acquires the plural pieces of normal-accuracy node information satisfying predetermined conditions.

### Embodiment 2

Described in the embodiment 1 is the case of performing the matching processing using the positional information. Described in the embodiment 2 is the case of performing the matching processing using azimuth information in addition to the positional information.

### <Configuration>

A configuration of an in-vehicle apparatus including a drive assist formulation apparatus according to an embodiment 2 is basically similar to that according to the embodiment 1. Accordingly, in the description hereinafter, the drive assist formulation apparatus according to the embodiment 2 is the drive assist formulation apparatus 9 illustrated in FIG. 2.

In the embodiment 2, the normal-accuracy node information outputted from the information processing apparatus 8 includes the normal-accuracy positional information and the normal-accuracy azimuth information. The normal-accuracy azimuth information is information indicating an azimuth of the normal-accuracy link entering or exiting from the normal-accuracy node. The association information stored in the association information table 15 includes the association positional information and association azimuth information. The association azimuth information is information indicating an azimuth of the high-accuracy link entering or exiting from the high-accuracy node.

### <Operation>

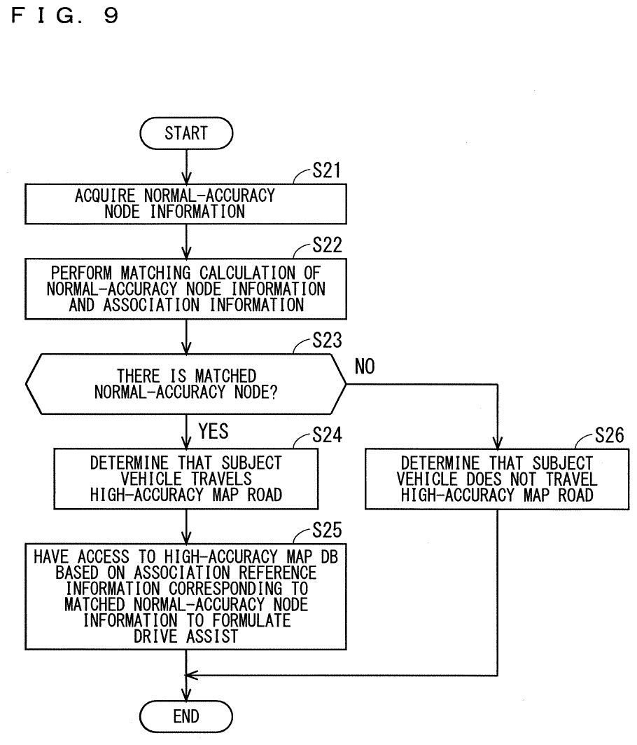

FIG. 9 is a flow chart illustrating an example of an operation of the drive assist formulation apparatus 9. As a premise of the operation illustrated in FIG. 9, the application execution unit 13 in the information processing apparatus 8 executes the route search or a route predication using the normal-accuracy map stored in the normal-accuracy map DB 12 to generate the normal-accuracy node information in a predetermined range in the travel route of the subject vehicle.

Each processing in Step S23, Step S24, and Step S26 is similar to that in Step S13, Step S14, and Step S16 in FIG. 3 described in the embodiment 1, thus the description is omitted herein.

In Step S21, the normal-accuracy node information acquisition unit 2 acquires one or plural pieces of normal-accuracy node information on the travel route of the subject vehicle from the information processing apparatus 8.

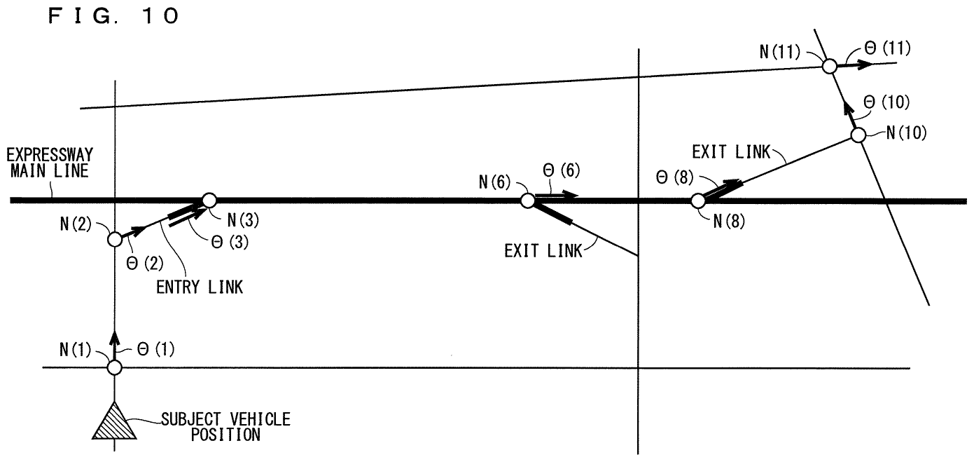

FIG. 10 is a diagram illustrating an example of the normal-accuracy node on the travel route. The normal-accuracy node information acquired by the normal-accuracy node information acquisition unit 2 includes a position of the normal-accuracy node N(n) and an azimuth Θ(n) in the normal-accuracy node N(n). The normal-accuracy node N(n) corresponds to a position indicated by the normal-accuracy positional information. The azimuth Θ(n) corresponds to an azimuth indicated by the normal-accuracy azimuth information. An arrow in FIG. 10 indicates an image of the Θ(n).

As illustrated in FIG. 10, the normal-accuracy node N(3) is a node entering (joining to) an expressway main line in the travel route, thus an azimuth Θ(3) is an azimuth of a link entering the normal-accuracy node N(3). Azimuths Θ(1), Θ(2), Θ(6), Θ(8), Θ(10), and Θ(11) are an azimuth along the travel route or an azimuth exiting (separating) from an expressway main line (going out of the link N(n)).

In Step S22, the association determination unit 4 determines whether or not the normal-accuracy node included in the normal-accuracy node information is associated with the high-accuracy node or the high-accuracy link stored in the high-accuracy map DB 14 based on the normal-accuracy node information acquired by the normal-accuracy node information acquisition unit 2 and the association information stored in the association information table 15 to specify the high-accuracy node or the high-accuracy link associated with the normal-accuracy node.

Specifically, the association determination unit 4 performs a first matching calculation and a second matching calculation. Performed in the first matching calculation (first association determination) is matching whether or not the normal-accuracy position is located near a position indicated by the association positional information based on the association positional information stored in the association information table 15 and the normal-accuracy position included in the normal-accuracy node information acquired by the normal-accuracy node information acquisition unit 2. Performed in the second matching calculation (second association determination) is matching of the azimuth indicated by the association azimuth information and the normal-accuracy azimuth indicated by the normal-accuracy azimuth information based on the association azimuth information stored in the association information table 15 and the normal-accuracy azimuth information included in the normal-accuracy node information acquired by the normal-accuracy node information acquisition unit 2.

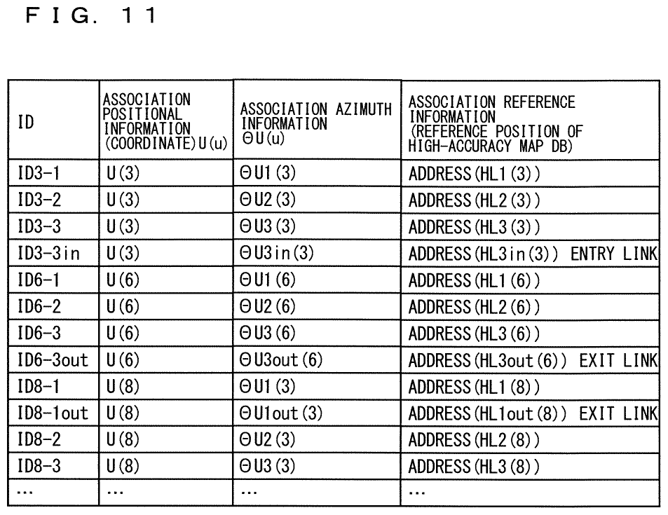

FIG. 11 is a diagram illustrating an example of the association information stored in the association information table 15. The association information illustrated in FIG. 11 is different from that illustrated in FIG. 6 described in the embodiment 1 in that the association azimuth information is added. The association reference information indicates a reference position of the high-accuracy map DB 14 for having access to the high-accuracy link.

The high-accuracy nodes HN1(3) and HN2(3) do not include the entry link, however, the high-accuracy node HN(3) includes the entry link, thus the ID-3-3in for the entry link is added, and the association reference information is set to refer to the entry link. In the similar manner, ID6-3out and ID8-1out for the exit link are added to the high-accuracy nodes HN3(6) and HN1(8) including the exit link. When there are a plurality of entry traffic lanes and exit traffic lanes, there are also plural pieces of IDn-in and IDn-out.

Described herein is the first matching calculation and the second matching calculation by the association determination unit 4.

### <First Matching Calculation>

In the first matching calculation, a distance from the position of the normal-accuracy node (normal-accuracy position N(n)) to the position U(u) indicated by the association positional information is calculated as expressed by the following expression (1). U(u) may be defined as a position, or may also be defined as a predetermined area. In a case where U(u) is defined as the predetermined area, when the normal-accuracy position is located in the predetermined area, the association determination unit 4 determines that the distance from the normal-accuracy position to the association positional information is 0.

$$f 1 = DIS \{ N ( n ) , U ( u ) \} \qquad ( 1 )$$

### <Second Matching Calculation>

In the second matching calculation, a difference between the azimuth of the normal-accuracy node (normal-accuracy azimuth Θ(n)) and the azimuth ΘU(u) indicated by the association azimuth information is calculated as expressed by the following expression (2). ΘU(u) may be defined as a specific azimuth, or may also be defined as a predetermined azimuth range. In a case where ΘU(u) is defined as the predetermined azimuth range, when the normal-accuracy azimuth is located in the predetermined azimuth range, the association determination unit 4 determines that the difference between the normal-accuracy azimuth and the azimuth indicated by the association azimuth information is 0.

$$f 2 = DIS \{ Θ ( n ) , ΘU ( u ) \} \qquad ( 2 )$$

Described next are determination examples 1 to 3 determined by the association determination unit 4 whether or not the normal-accuracy node information matches the association information in consideration of each result of the first matching calculation and the second matching calculation.

### Determination Example 1 of Matching

The association determination unit 4 determines that the matching is established when f1 satisfies a predetermined condition and f2 satisfies a predetermined condition.

For example, the association determination unit 4 determines that the matching is established when f1 DISth and f2≤DISΘth are satisfied.

### Determination Example 2 of Matching

When the association positional information U(u) is defined as a predetermined area and the association azimuth information ΘU(u) is defined as a predetermined azimuth range, the association determination unit 4 determines that the matching is established when f1=0 and f2=0 are satisfied, for example.

### Determination Example 3 of Matching

The association determination unit 4 may determine whether or not the matching is established in comprehensively consideration of both f1 and f2.

For example, the association determination unit 4 may determine that the matching is established when f1·α1+f2·α2 is equal to or smaller than a predetermined value. Herein, α1 and α2 are weighting coefficients.

The association determination unit 4 determines whether or not the normal-accuracy node information matches the association information using any one of the determination examples 1 to 3 described above.

As described above, in Step S22, the association determination unit 4 performs the matching of the normal-accuracy node information illustrated in FIG. 10 and the association information illustrated in FIG. 11. At this time, the azimuth information is used, thus the result is different from that in the embodiment 1.

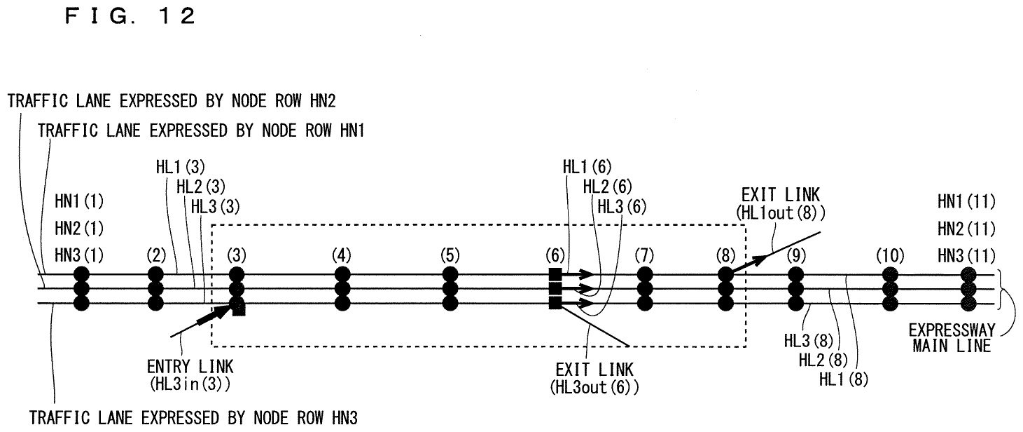

In the example in FIGS. 10 and 11, it is determined that the matching of each of ID3-3in, ID6-1, ID6-2, ID6-3, and ID8-1out is established by performing the determination described above. Then, the normal-accuracy node N(3) is associated with the entry link HL3in3 connected to the high-accuracy node HN3(3), the normal-accuracy node N(6) is associated with the high-accuracy links HL1(6), HL2(6), and HL3(6), and the normal-accuracy node N(8) is associated with the exit link HL1out(8) based on the association reference information corresponding to each ID. FIG. 12 is a diagram illustrating an example of the high-accuracy node associated with the normal-accuracy node.

Returning to the description of FIG. 9, in Step S25, the drive assist formulation unit 6 has access to the high-accuracy map DB 14 based on the association reference information corresponding to the matched normal-accuracy node information to acquire the high-accuracy link associated with the normal-accuracy node information. Then, the drive assist formulation unit 6 formulates the drive assist using the acquired high-accuracy link.

In the embodiment 1, it is determined whether or not the subject vehicle passes through the high-accuracy node based on an estimation of entering the high-accuracy map road from an outer side of the high-accuracy map road, continuing to travel the high-accuracy map road, and exiting to the outer side of the high-accuracy map road from the high-accuracy map road. In the meanwhile, in the embodiment 2, it is clarified by the matching processing whether or not the subject vehicle travels the entry link or the exit link, thus the above estimation in the embodiment 1 is unnecessary.

### Modification Example 1

The embodiment 2 describes the case where the association reference information is information having access to the high-accuracy link, however, the configuration is not limited thereto. The association reference information may be information having access to the high-accuracy node in the manner similar to the embodiment 1.

### Modification Example 2

Described in the embodiment 1 and the embodiment 2 is the case where there is one entry link or one exit link for a specific node as the example, however, the configuration is not limited thereto. It is also applicable that there are a plurality of entry links for a specific node, a plurality of exit links for a specific node, and one or more entry links and one or more exit links for a specific node.

In the example illustrated in FIGS. 10 to 12, when the normal-accuracy node N(3) includes two entry links, the association information includes two IDs for entry such as ID3-3in1 and ID3-3in2. The azimuth information is used in the embodiment 2, the determination from which entry link the subject vehicle enters the high-accuracy map road can be performed, for example.

There may be an entry link for a plurality of traffic lanes in the high-accuracy map road for the normal-accuracy node N(3). For example, there may be an entry link to not only the high-accuracy node HN3(3) but also the high-accuracy node HN1(3). There may be an exit link in the high-accuracy nodes HN1(6) and HN3(8) in the similar manner regarding exit.

One normal-accuracy node may correspond to a plurality of high-accuracy nodes whose types, that is entry node and exit node, are different from each other such as a case where the high-accuracy node HN1(6) includes the entry link and the high-accuracy node HN3(6) includes the exit link.

### Modification Example 3

Described in the embodiment 2 is the case where the normal-accuracy azimuth information includes only one azimuth corresponding to entry, exit, or a road, however, the configuration is not limited thereto. It is also applicable that two pieces of azimuth information, that is azimuth information of the normal-accuracy link connected to the normal-accuracy node on the travel route and azimuth information of the normal-accuracy link starting from the normal-accuracy node, are defined as normal-accuracy azimuth information, and the association azimuth information also includes two azimuths in the similar manner.

Herein, “the azimuth information of the normal-accuracy link connected to the normal-accuracy node on the travel route” indicates azimuth information of two links (a link of N(2) to N(3) and a link of N(3) to N (6)) connected to the normal-accuracy node N(3) on the route. “The azimuth information of the normal-accuracy link starting from the normal-accuracy node” indicates a link of N(3) to N(6) connected to the normal-accuracy node N(3) in FIG. 10, for example.

In this manner, two azimuth information is used, thus the matching accuracy is improved.

### Modification Example 4

Described in the embodiment 1 and the embodiment 2 is the case where the drive assist formulation apparatus 9 acquires the normal-accuracy node information regarding the entry node and the exit node on the travel route, however, the configuration is not limited thereto. It is also applicable that the information processing apparatus 8 sets an intermediate node when a predetermined node addition condition is satisfied between a specific node and a next node and outputs the normal-accuracy node information corresponding to the intermediate node. In this case, the drive assist formulation apparatus 9 acquires the normal-accuracy node information including the intermediate node.

Herein, the node addition condition indicates that when the specific node and the next node are away from each other by a predetermined distance (for example, 3 km) or more, the intermediate node is added between those nodes. One or the plurality of intermediate nodes are set so that a distance to and from the intermediate nodes or from the original node to the intermediate node is within a predetermined distance (for example, 3 km).

For example, when a distance from a specific node to a next node is larger than 3 km and equal to or smaller than 6 km, one intermediate node is set to a center position between two nodes. When a distance from a specific node to a next node is larger than 6 km and equal to or smaller than 9 km, two intermediate nodes are set to at regular intervals. The position of the intermediate node is not limited to the center position of two nodes but may be set to a point with a predetermined distance (for example, 3 km) from a specific node.

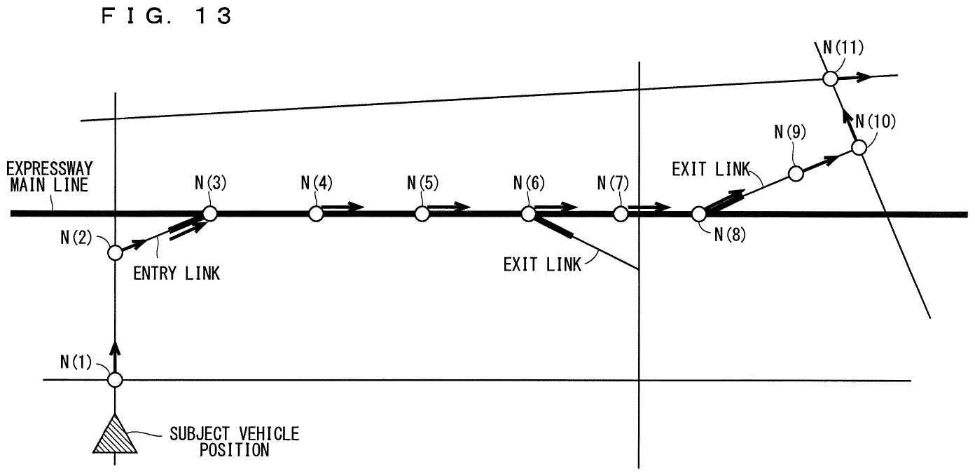

The association information is set to the intermediate node set as described above. For example, when a distance from the normal-accuracy nodes N(3) to N(6) is 8.7 km, and when a distance from N(6) to N(8) is 5 km, the intermediate nodes N(4) and N(5) are set to positions at regular intervals (2.9 km) from N(3) and N(6). In the similar manner, the intermediate node N(7) is set to a position of 2.5 km between N(6) and N(8). FIG. 13 illustrates the intermediate nodes N(4), N(5), and N(7) set as described above.

FIG. 12 illustrates a case where the intermediate node and the high-accuracy node are located in substantially the same position, however, a position corresponding to the intermediate node in the high-accuracy map and a position corresponding to the intermediate node in the normal-accuracy map are not generally located in the same position. Accordingly, as with the association information illustrated in FIG. 11, it is preferable that the normal-accuracy node is not associated with the high-accuracy node but is associated with the high-accuracy link.

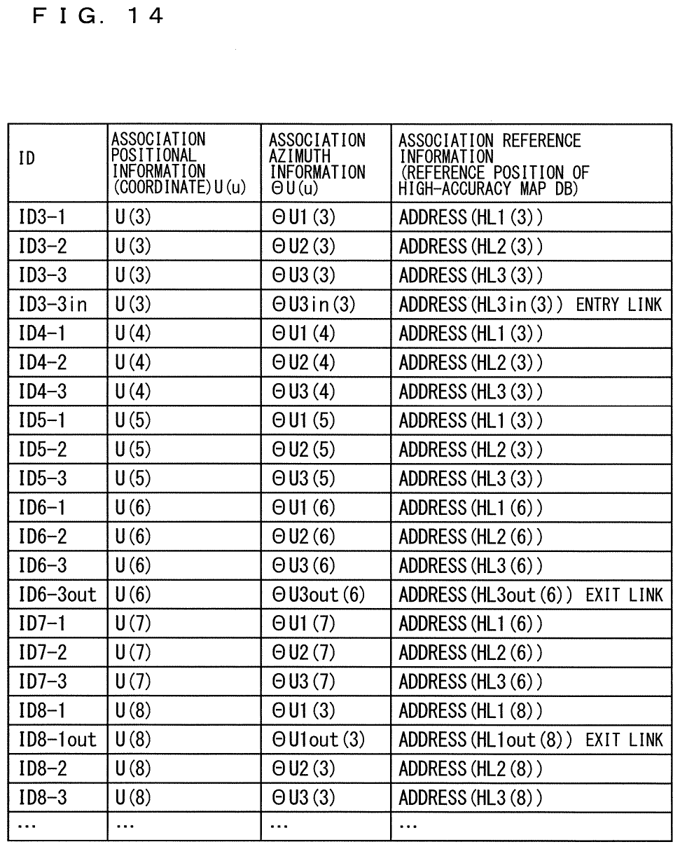

In the modification example, 4, one high-accuracy link connects the entry nodes or exit nodes. In this case, the association information is as illustrated in FIG. 14. As illustrated in FIG. 14, ID3-1, ID4-1, and ID5-1 refer to the same high-accuracy link. The connection between the entry nodes or exit nodes may be expressed by a plurality of high-accuracy links.

Described hereinafter is a case where the information processing apparatus 8 outputs high-accuracy node information within a range 20 km ahead from a subject vehicle position. When the normal-accuracy node N(6) is located in a position 21 km ahead from the subject vehicle, N(3) and N(6) are away from each other by 8.7 km, thus N(3) is located 12.3 km (21 km−8.7 km=12.3 km) ahead from the subject vehicle position. In this case, it cannot be accurately grasped whether or not the subject vehicle travels the high-accuracy map road at a position 12.3 km to 20 km ahead from the subject vehicle position in the embodiment 2. In the meanwhile, the information within a range of N(5) is included in the modification example 4, thus it can be determined whether or not the subject vehicle travels the high-accuracy map road within a position of N(5), that is to say, within a range of 12.3 km+2.9 km×2=18.1 km.

It can be normally determined that the subject vehicle travels the high-accuracy map road until a next exit link (for example, an interchange) appears during traveling the high-accuracy map road, and such a configuration is efficient in a case where a map version stored in the normal-accuracy map DB of the information processing apparatus 8 and a map version stored in the high-accuracy map DB 14 of the drive assist formulation apparatus 9 are different from each other, and one of them does not include newly provided interchange information, for example.

### Embodiment 3

Described in the embodiment 1 is the case of performing the matching processing using the positional information. Described in the embodiment 3 is the case of performing the matching processing using a link attribute in addition to the positional information.

### <Configuration>

A configuration of an in-vehicle apparatus including a drive assist formulation apparatus according to the embodiment 3 is basically similar to that according to the embodiment 1. Accordingly, in the description hereinafter, the drive assist formulation apparatus according to the embodiment 3 is the drive assist formulation apparatus 9 illustrated in FIG. 2.

In the embodiment 3, the normal-accuracy node information outputted from the information processing apparatus 8 includes the normal-accuracy positional information and a normal-accuracy link attribute. The normal-accuracy link attribute is an attribute of the normal-accuracy link entering or exiting from the normal-accuracy node. The association information stored in the association information table 15 includes the association positional information and an association link attribute. The association link attribute indicates the attribute of the high-accuracy link entering or exiting from the high-accuracy node.

### <Operation>

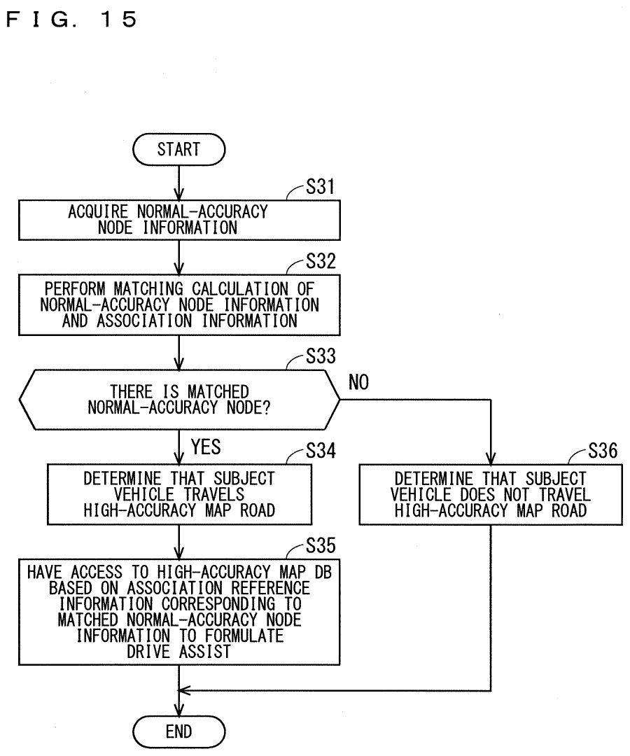

FIG. 15 is a flow chart illustrating an example of an operation of the drive assist formulation apparatus 9. As a premise of the operation illustrated in FIG. 15, the application execution unit 13 in the information processing apparatus 8 executes the route search or a route predication using the normal-accuracy map stored in the normal-accuracy map DB 12 to generate the normal-accuracy node information in a predetermined range in the travel route of the subject vehicle.

Each processing in Step S33, Step S34, and Step S36 is similar to that in Step S13, Step S14, and Step S16 in FIG. 3 described in the embodiment 1, thus the description is omitted herein.

In Step S31, the normal-accuracy node information acquisition unit 2 acquires one or plural pieces of normal-accuracy node information on the travel route of the subject vehicle from the information processing apparatus 8.

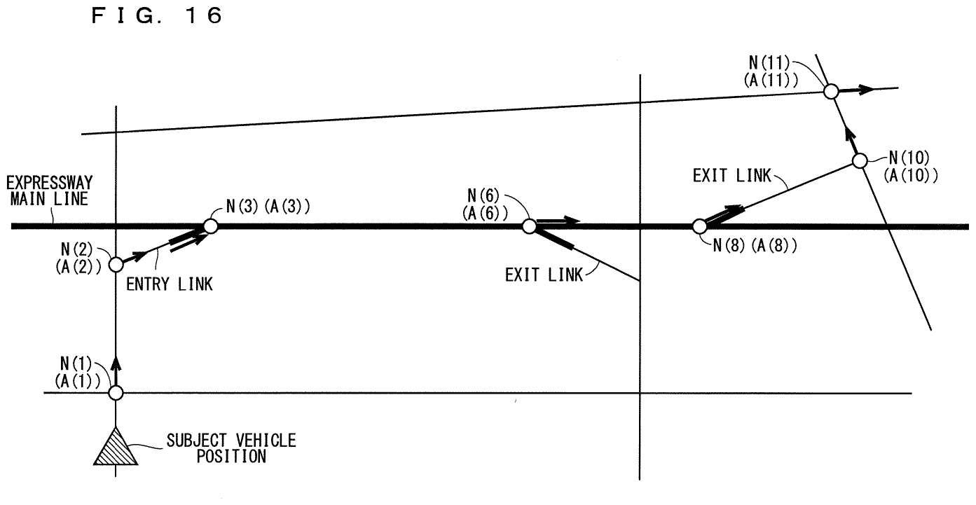

FIG. 16 is a diagram illustrating an example of the normal-accuracy node on the travel route. As illustrated in FIG. 16, normal-accuracy link attributes A(1) and A(6) corresponding to the normal-accuracy nodes N(1) and N(6) as the road, respectively, are “road” in the travel route of the subject vehicle. Normal-accuracy link attributes A(2), A(8), A(10), and A(11) corresponding to the branched normal-accuracy nodes N(2), N(8), N(10), and N(11), respectively are “exit”. A normal-accuracy link attribute A(3) corresponding to the entering normal-accuracy node N(3) is “entry.”

In Step S32, the association determination unit 4 determines whether or not the normal-accuracy node included in the normal-accuracy node information is associated with the high-accuracy node or the high-accuracy link stored in the high-accuracy map DB 14 based on the normal-accuracy node information acquired by the normal-accuracy node information acquisition unit 2 and the association information stored in the association information table 15 to specify the high-accuracy node or the high-accuracy link associated with the normal-accuracy node.

Specifically, the association determination unit 4 performs a third matching calculation and a fourth matching calculation. Performed in the third matching calculation (third association determination) is matching whether or not the normal-accuracy position is located near a position indicated by the association positional information based on the association positional information stored in the association information table 15 and the normal-accuracy position included in the normal-accuracy node information acquired by the normal-accuracy node information acquisition unit 2. Herein, the third matching calculation corresponds to the first matching calculation described above. Performed in the fourth matching calculation (fourth association determination) is matching whether or not the association link attribute stored in the association information table 15 coincides with the normal-accuracy link attribute included in the normal-accuracy node information acquired by the normal-accuracy node information acquisition unit 2.

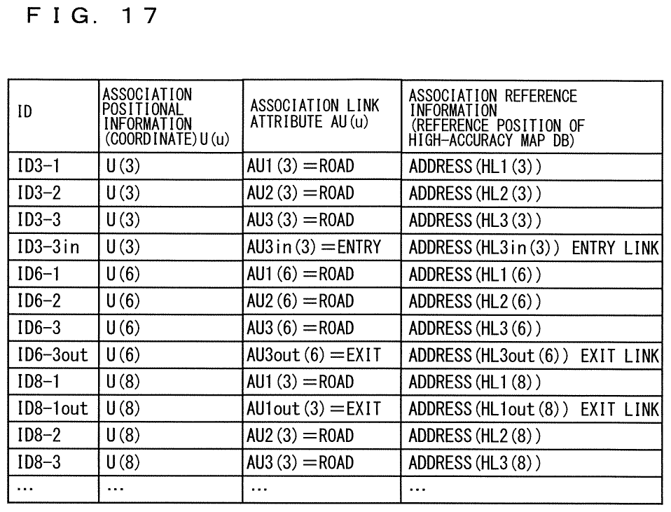

FIG. 17 is a diagram illustrating an example of the association information stored in the association information table 15. The association information illustrated in FIG. 17 is different from that illustrated in FIG. 6 described in the embodiment 1 in that the association azimuth information is added. The association reference information indicates a reference position of the high-accuracy map DB 14 for having access to the high-accuracy link in the manner similar to the association reference information in FIG. 14 described in the embodiment 2.

The association information illustrated in FIG. 17 is different from that illustrated in FIG. 6 described in the embodiment 1 in that ID3-3in, ID6-3out, and ID8-1out are added in the manner similar to the association information in FIG. 14 described in the embodiment 2.

The normal-accuracy node information acquired by the normal-accuracy node information acquisition unit 2 includes N(n) and A(n) (n=1, 2, 3, 6, 8, 10, 11) as illustrated in FIG. 16. The association determination unit 4 performs the third matching calculation and the fourth matching calculation, thereby determining that the matching of ID3-3in, ID6-1, ID6-2, ID6-3, and ID8-1out are established. According to the determination, the normal-accuracy node N(3) is associated with the entry link HL3in (3). The normal-accuracy node N(6) is associated with the high-accuracy links HL1(6), HL2(6), and HL3(6). The normal-accuracy node N(8) is associated with the exit link HL1out(8).

The high-accuracy link associated with the normal-accuracy node by the matching result is similar to that in FIG. 12 described in the embodiment 2.

Returning to the description of FIG. 15, in Step S35, the drive assist formulation unit 6 has access to the high-accuracy map DB 14 based on the association reference information corresponding to the matched normal-accuracy node information to acquire the high-accuracy link associated with the normal-accuracy node information. Then, the drive assist formulation unit 6 formulates the drive assist using the acquired high-accuracy link.

In the embodiment 1, it is determined whether or not the subject vehicle passes through the high-accuracy node based on an estimation of entering the high-accuracy map road from an outer side of the high-accuracy map road, continuing to travel the high-accuracy map road, and exiting to the outer side of the high-accuracy map road from the high-accuracy map road. In the meanwhile, in the embodiment 3, it is clarified by the matching processing whether or not the subject vehicle travels the entry link or the exit link, thus the above estimation in the embodiment 1 is unnecessary.

### Modification Example 1

The embodiment 3 describes the case where the association reference information is information having access to the high-accuracy link, however, the configuration is not limited thereto. The association reference information may be information having access to the high-accuracy node in the manner similar to the embodiment 1.

### Modification Example 2

The embodiment 3 describes the case of defining the link attribute regarding entry or exit, however, the configuration is not limited thereto.

For example, the link attribute may be a road type such as an expressway, a general road, or a narrow street.

### Modification Example 3

The link attribute may include the number of exit links indicating the number of exit links exiting from the node or the number of entry links indicating the number of entry links entering the node. In this case, set is the association information associated with each of the exit links corresponding to the number of exit links, the entry links corresponding to the number of entry links, and the road links.

### Modification Example 4

When there are a plurality of exit links in which a traveling direction of the high-accuracy map road is “1”, the link attribute may be information indicating a clockwise order of the exit link from the traveling direction as a start point (first). Example of the case where there are a plurality of exit links include a case where there are a plurality of exits from one interchange (IC).

When the normal-accuracy map stored in the normal-accuracy map DB includes the link attribute of the plurality of exit links, the drive assist formulation apparatus 9 can perform matching by acquiring the normal-accuracy node information including the link attribute indicating what number of links is determined as the route.

### Modification Example 5

Described in the embodiment 3 is the case of performing matching using the positional information and the link attribute, however, the configuration is not limited thereto. For example, it is applicable to add the azimuth information described in the embodiment 2 and perform matching using the positional information, the azimuth information, and the link attribute.

Specifically, the normal-accuracy node information includes the normal-accuracy azimuth information indicating the azimuth of the normal-accuracy link entering or exiting from the normal-accuracy node and the normal-accuracy link attribute indicating the attribute of the normal-accuracy link entering or exiting from the normal-accuracy node. The association information includes the association azimuth information indicating the azimuth of the high-accuracy link entering or exiting from the high-accuracy node and the association link attribute indicating the attribute of the high-accuracy link entering or exiting from the high-accuracy node. The association determination unit 4 determines whether or not the normal-accuracy position is associated to the high-accuracy node or the high-accuracy link based on a fifth matching calculation (fifth association determination) determining whether or not the normal-accuracy positional information is associated with the association positional information, a sixth matching calculation (sixth association determination) determining whether or not the normal-accuracy positional information is associated with the association azimuth information, and a seventh matching calculation (seventh association determination) determining whether or not the normal-accuracy link attribute is associated with the association link attribute. Herein, the fifth matching calculation corresponds to the first and third matching calculations described above. The sixth matching calculation corresponds to the second matching calculation described above. The seventh matching calculation corresponds to the fourth matching calculation described above.

Association accuracy is improved more than the embodiments 2 and 3 in a case where a large number of nodes are mixedly located near the normal-accuracy node N(n).

### Embodiment 4

The embodiments 1 to 3 describe the case of providing the association information table 15 separately from the high-accuracy map DB 14. An embodiment 4 describes a case of storing the association information in the high-accuracy map DB 14.

### <Configuration>

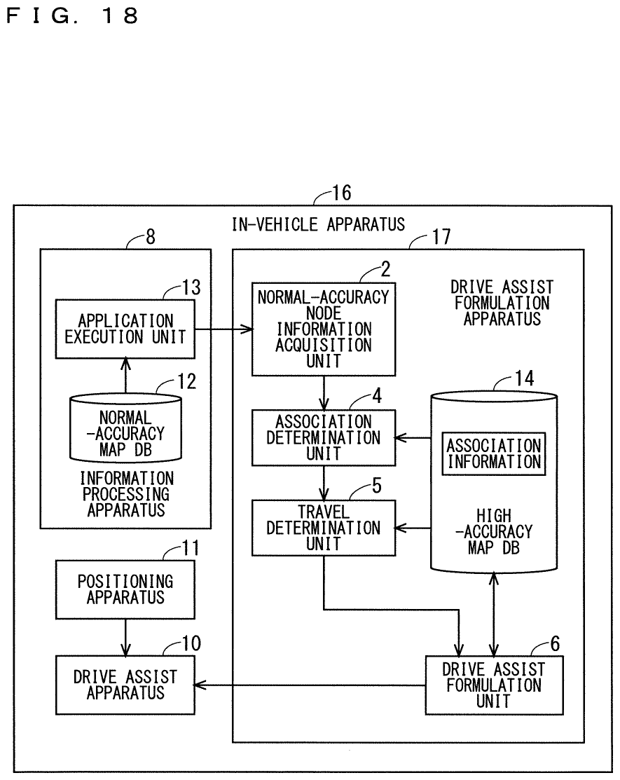

FIG. 18 is a block diagram illustrating an example of a configuration of an in-vehicle apparatus 16 including a drive assist formulation apparatus 17 according to the embodiment 4.

As illustrated in FIG. 18, the drive assist formulation apparatus 17 has a feature that the high-accuracy map DB 14 stores the association information. The other configuration and a basic operation are similar to those in the drive assist formulation apparatus 9 in FIG. 2 described in the embodiment 1.

In the high-accuracy map DB 14, the association positional information included in the association information is included in the attribute information of the high-accuracy node or the high-accuracy link. The association reference information included in the association information uses a data record for having access to the high-accuracy node or the high-accuracy link originally provided to the high-accuracy map DB 14.

### <Operation>

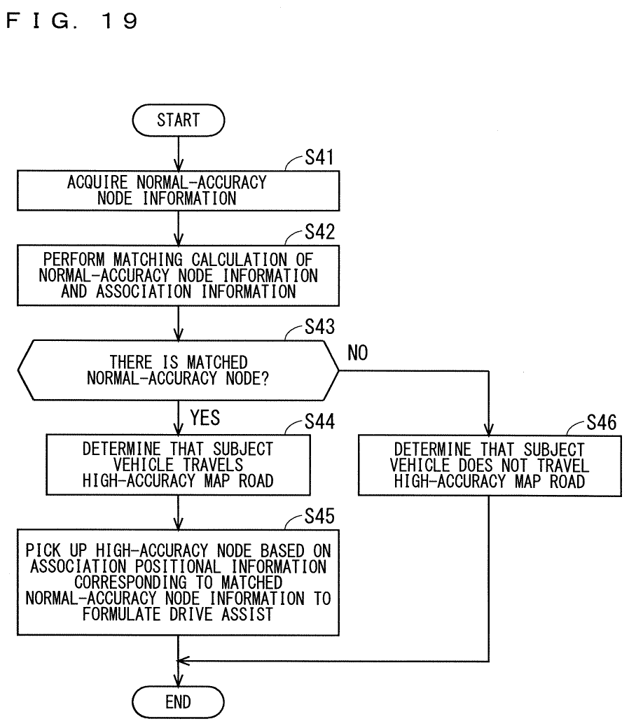

FIG. 19 is a flow chart illustrating an example of an operation of the drive assist formulation apparatus 17. As a premise of the operation illustrated in FIG. 19, the application execution unit 13 in the information processing apparatus 8 executes the route search or a route predication using the normal-accuracy map stored in the normal-accuracy map DB 12 to generate the normal-accuracy node information in a predetermined range in the travel route of the subject vehicle. Description hereinafter is based on the state of FIGS. 4 and 5 described in the embodiment 1.

Each processing in Step S43, Step S44, and Step S46 is similar to that in Step S13, Step S14, and Step S16 in FIG. 3 described in the embodiment 1, thus the description is omitted herein.

In Step S41, the normal-accuracy node information acquisition unit 2 acquires one or plural pieces of normal-accuracy node information on the travel route of the subject vehicle from the information processing apparatus 8.

In the example in FIG. 4, the normal-accuracy node information acquisition unit 2 acquires the normal-accuracy node information of the normal-accuracy nodes N(1), N(2), N(3), N(6), N(8), N(10), and N(11).

In Step S42, the association determination unit 4 determines whether or not the normal-accuracy node included in the normal-accuracy node information is associated with the high-accuracy node or the high-accuracy link stored in the high-accuracy map DB 14 based on the normal-accuracy node information acquired by the normal-accuracy node information acquisition unit 2 and the association information stored in the association information table 15 to specify the high-accuracy node or the high-accuracy link associated with the normal-accuracy node.

Specifically, the association determination unit 4 performs the matching calculation in order from the normal-accuracy node N(1). However, when the association determination unit 4 performs the matching on all of the high-accuracy nodes and the normal-accuracy node N(1) included in the high-accuracy map, a calculation time is increased, thus the association determination unit 4 previously narrows the high-accuracy node on which the matching is to be performed.

For example, the association determination unit 4 narrows the high-accuracy node to determine the high-accuracy node near the normal-accuracy node N(n) as a first candidate. Herein, the state of near the normal-accuracy node N(n) indicates, for example, the same mesh, an adjacent mesh, or a predetermined distance (for example, 400 m) from the normal-accuracy node N(n).

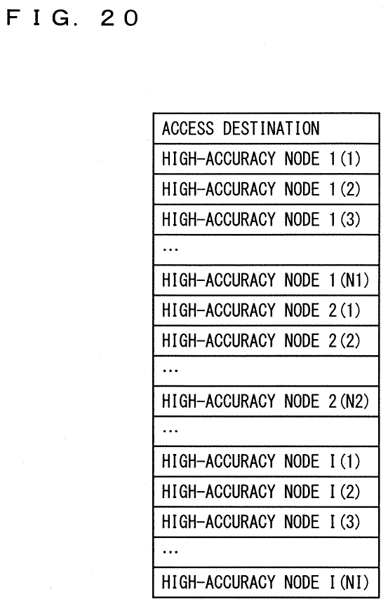

FIG. 20 is a diagram illustrating an example of a high-accuracy node access data record. The high-accuracy node access data record is information originally provided to the high-accuracy map DB 14 regardless of the association information. The high-accuracy node access data record stores a pointer information group to have access to the high-accuracy node data record storing data of the high-accuracy node. Although not illustrated in FIG. 20, each pointer information corresponds to a mesh ID including the high-accuracy node.

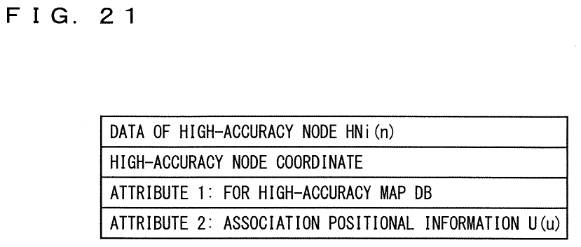

FIG. 21 is a diagram illustrating an example of the high-accuracy node data record. As illustrated in FIG. 21, data of the high-accuracy node HNi(n) includes a high-accuracy node coordinate (positional information) originally included in the high-accuracy map DB 14, an attribute 1 such as a road type, and an attribute 2 storing the association positional information. In the embodiment 4, the high-accuracy node data record includes the attribute 2. The attribute 2 may store the association ID in the manner similar to the embodiment 1.

The association determination unit 4 has access to all of the high-accuracy node data records located near the normal-accuracy position N(n) using the high-accuracy node access data record to pick up all of the high-accuracy nodes having the association positional information matching N(n).

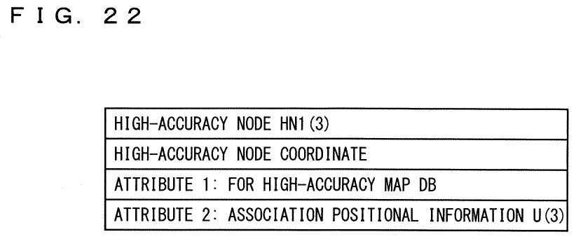

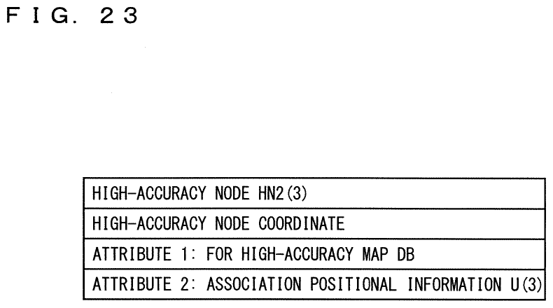

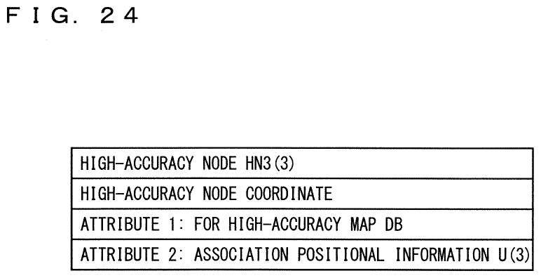

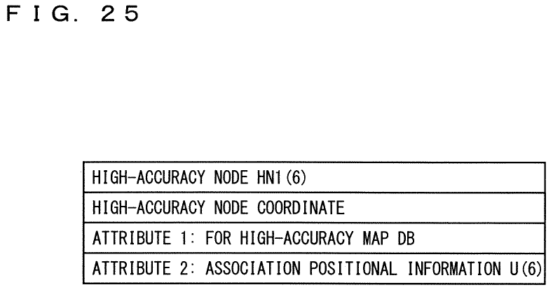

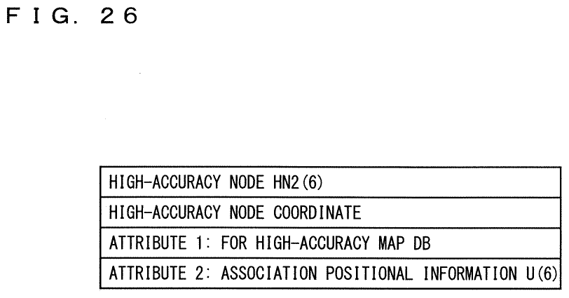

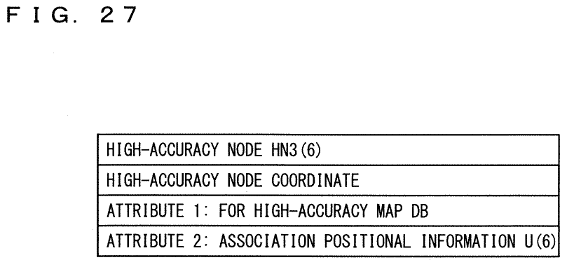

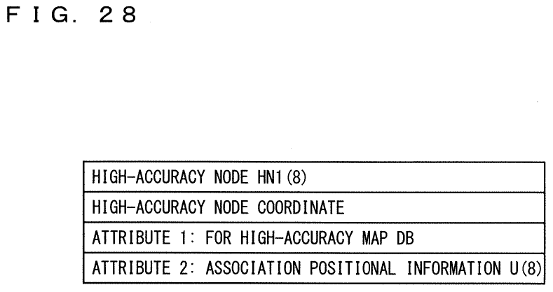

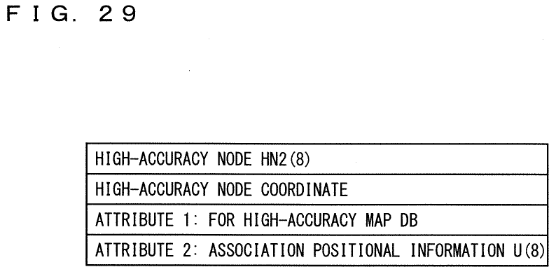

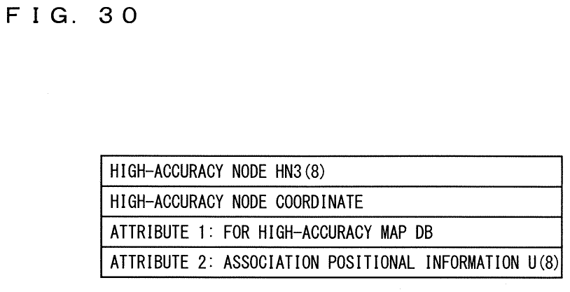

In the example in FIGS. 4 and 5, as illustrated in FIGS. 22 to 24, the high-accuracy nodes HN1(3), HN2(3), and HN3(3) having the attribute 2 storing the association positional information U(3) match the normal-accuracy node N(3). As illustrated in FIGS. 25 to 27, the high-accuracy nodes HN1(6), HN2(6), and HN3(6) having the attribute 2 storing the association positional information U(6) match the normal-accuracy node N(6). As illustrated in FIGS. 28 to 30, the high-accuracy nodes HN1(8), HN2(8), and HN3(8) having the attribute 2 storing the association positional information U(8) match the normal-accuracy node N(8).

Returning to the description of FIG. 19, in Step S45, the drive assist formulation unit 6 picks up the high-accuracy node based on the association positional information corresponding to the matched normal-accuracy node information. Then, the drive assist formulation unit 6 formulates the drive assist using the high-accuracy node which has been picked up.

In the manner similar to the embodiment 1, the subject vehicle enters the high-accuracy map road from the normal-accuracy map road at the position of the normal-accuracy node N(3), thus the high-accuracy node associated with the normal-accuracy node N(3) is only HN3(3). The subject vehicle exits to the normal-accuracy map road from the high-accuracy map road at the position of the normal-accuracy node N(8), thus the high-accuracy node associated with the normal-accuracy node N(8) is only HN1(8). The high-accuracy node associated with the normal-accuracy node N(6) is still HN1(6), HN2(6), and HN3(6). Accordingly, the node and the link which the subject vehicle may travel are similar to those in FIG. 8 described in the embodiment 1.

Differing from the embodiment 1, the drive assist formulation unit 6 has already access to the data of the high-accuracy node, thus formulates the drive assist using the information of the high-accuracy node which the drive assist formulation unit 6 has access or the information of the high-accuracy link connected to the high-accuracy node. That is to say, processing load in the drive assist formulation apparatus 17 is reduced more than that in the embodiment 1, and a processing time can be reduced.

### Modification Example 1

The embodiment 4 describes the case where the association positional information is stored in the attribute 2 of the high-accuracy node, however, the configuration is not limited thereto. The association positional information may be stored in the attribute 2 of the high-accuracy link. In this case, the association information is also stored in the entry link and the exit link, thus the association positional information U(3) is stored in the attribute 2 of the high-accuracy links HL1(3), HL2(3), HL3(3), and the entry link HL3in (3) associated with the normal-accuracy node N(3), for example. The association positional information U(3) matches the normal-accuracy node N(3).

The association positional information U(6) is stored in the attribute 2 of the high-accuracy links HL1(6), HL2(6), HL3(6), and the exit link HL3out (6) associated with the normal-accuracy node N(6). The association positional information U(6) matches the normal-accuracy node N(6).

The association positional information U(8) is stored in the attribute 2 of the high-accuracy links HL1(8), HL2(8), HL3(8), and the exit link HL3out (8) associated with the normal-accuracy node N(8). The association positional information U(8) matches the normal-accuracy node N(8).

### Embodiment 5

The embodiment 4 describes the case of storing the association positional information in the attribute 2 of the high-accuracy node, and the modification example 1 of the embodiment 4 describes the case of storing the association positional information in the attribute 2 of the high-accuracy link. An embodiment 5 describes a case of storing a combination of the embodiment 2 and the embodiment 4, that is to say, the association positional information and the association azimuth information in the attribute 2 of the high-accuracy link.

### <Configuration>

A configuration of an in-vehicle apparatus including a drive assist formulation apparatus according to the embodiment 5 is basically similar to that according to the embodiment 4. Accordingly, in the description hereinafter, the drive assist formulation apparatus according to the embodiment 5 is the drive assist formulation apparatus 17 illustrated in FIG. 18.

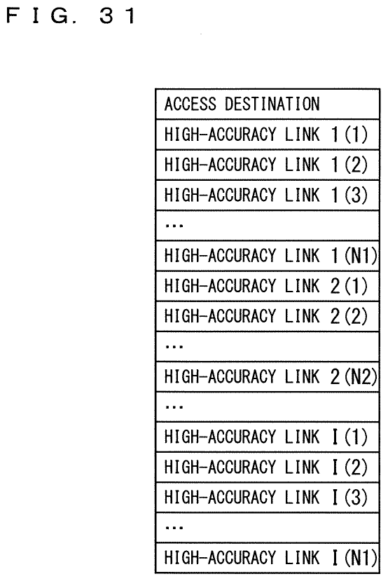

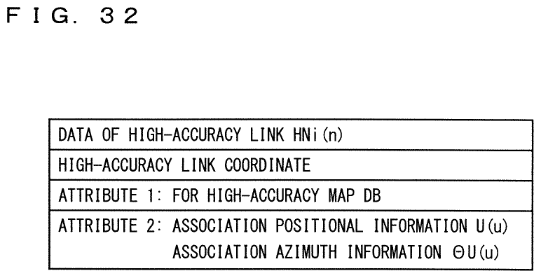

FIG. 31 is a diagram illustrating an example of a high-accuracy link access data record. FIG. 32 is a diagram illustrating an example of a high-accuracy link data record.

As illustrated in FIG. 32, the association positional information and the association azimuth information are stored in the attribute 2 of the high-accuracy link stored in the high-accuracy map DB 14.

### <Operation>

The operation of the drive assist formulation apparatus 17 is an operation in which the operation in FIG. 9 described in the embodiment 2 and the operation in the modification example 1 of the embodiment 4 are combined. A result of matching and a result of the drive assist formulation are similar to those in the embodiment 2.

### Modification Example 1

A configuration in which the embodiment 3 and the embodiment 4 are combined is also applicable. In this case, the information processing apparatus 8 outputs the normal-accuracy node information including the link attribute. The association positional information and the association link attribute are stored in the attribute 2 of the high-accuracy link or the high-accuracy node stored in the high-accuracy map DB 14. The matching processing may be similar to that in the embodiment 3.

### Embodiment 6

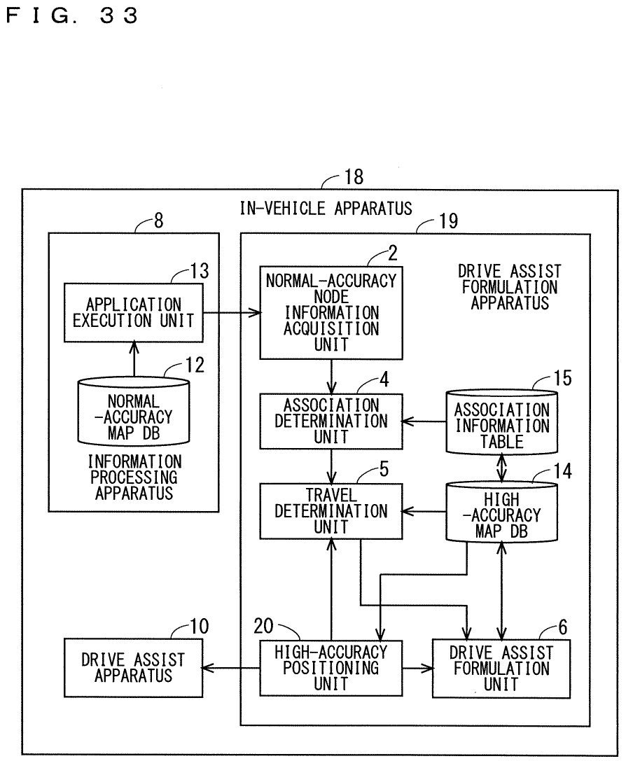

FIG. 33 is a block diagram illustrating an example of a configuration of an in-vehicle apparatus 18 including a drive assist formulation apparatus 19 according to an embodiment 6.

As illustrated in FIG. 33, the drive assist formulation apparatus 19 has a feature that it includes a high-accuracy positioning unit 20. The other configuration is similar to any configuration in the embodiments 1 to 3, thus the detailed description is omitted herein. The high-accuracy positioning unit 20 be included in the drive assist formulation apparatus 17 in FIG. 18 described in the embodiment 4.

The high-accuracy positioning unit 20 has a function of positioning a travel position of the subject vehicle on an order of several tens of centimeters and a function of detecting a travel traffic lane of the subject vehicle.

### <Operation>

The drive assist formulation apparatus 19 can formulate the drive assist in accordance with the travel traffic lane and the travel position where the subject vehicle currently travels.

For example, in Step S15 in FIG. 3 described in the embodiment 1, information of guiding an appropriate travel traffic lane which the subject vehicle should travel to exit from an exit link in accordance with a travel position.

For example, when the travel position gets closer to be within a predetermined distance from the exit node HN1(8), in a case where the subject vehicle is located in a traffic lane which is not connected to the exit node HN1(8), that is to say, a traffic lane connected to the high-accuracy node HN2(6) or HN3(6), guide information to travel a traffic lane connected to the high-accuracy node HN1(6) can be outputted.

### <Hardware Configuration>

Each function of the normal-accuracy node information acquisition unit 2, the association determination unit 4, the travel determination unit 5, and the drive assist formulation unit 6 in the drive assist formulation apparatus 9 described in the embodiment 1 is achieved by a processing circuit. That is to say, the drive assist formulation apparatus 9 includes a processing circuit acquiring normal-accuracy node information, determining whether or not the normal-accuracy node is associated with a high-accuracy node or a high-accuracy link to specify the high-accuracy node or the high-accuracy link associated with the normal-accuracy node, determining that the subject vehicle travels the high-accuracy map road, and formulating a drive assist using the high-accuracy node associated with the normal-accuracy node information. The processing circuit may be dedicated hardware or a processor (also referred to as a CPU, a central processor, a processing device, an arithmetic device, a microprocessor, a microcomputer, or a digital signal processor (DSP)) executing a program stored in a memory.

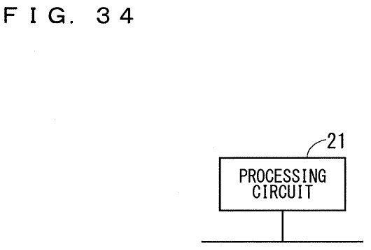

When the processing circuit is the dedicated hardware, a single circuit, a complex circuit, a programmed processor, a parallel-programmed processor, an application specific integrated circuit (ASIC), a field-programmable gate array (FPGA), or a combination of them, for example, falls under a processing circuit 21 as illustrated in FIG. 34. Each function of the normal-accuracy node information acquisition unit 2, the association determination unit 4, the travel determination unit 5, and the drive assist formulation unit 6 may be achieved by the processing circuit 21 or each function may be collected to be achieved by one processing circuit 21.

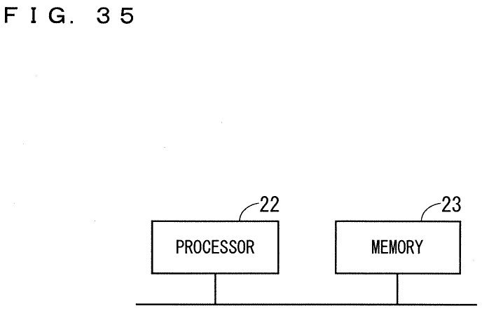

When the processing circuit 21 is a processor 22 illustrated in FIG. 35, each function of the normal-accuracy node information acquisition unit 2, the association determination unit 4, the travel determination unit 5, and the drive assist formulation unit 6 is achieved by software, firmware, or a combination of software and firmware. The software or the firmware is described as a program and is stored in a memory 23. The processor 22 reads out and executes a program stored in the memory 23, thereby achieving each function. That is to say, the drive assist formulation apparatus 9 includes the memory 23 for storing a program resultingly executing a step of acquiring normal-accuracy node information, a step of determining whether or not the normal-accuracy node is associated with a high-accuracy node or a high-accuracy link to specify the high-accuracy node or the high-accuracy link associated with the normal-accuracy node, a step of determining that the subject vehicle travels the high-accuracy map road, and a step of formulating a drive assist using the high-accuracy node associated with the normal-accuracy node information. These programs are also deemed to make a computer execute procedures or methods of the normal-accuracy node information acquisition unit 2, the association determination unit 4, the travel determination unit 5, and the drive assist formulation unit 6. Herein, a memory may be a non-volatile or volatile semiconductor memory such as a random access memory (RAM), a read only memory (ROM), a flash memory, an erasable programmable read only memory (EPROM), and an electrically erasable programmable read only memory (EEPROM), or, a magnetic disc, a flexible disc, an optical disc, a compact disc, a digital versatile disc (DVD), or any storage medium which is to be used in the future.

It is also applicable that some of each function of the normal-accuracy node information acquisition unit 2, the association determination unit 4, the travel determination unit 5, and the drive assist formulation unit 6 is achieved by dedicated hardware and the other function thereof is achieved by software or firmware.

As described above, the processing circuit can achieve each function described above by the hardware, the software, the firmware, or the combination of them.

Described above is the hardware configuration of the drive assist formulation apparatus 9 described in the embodiment 1, however, the same applies to the hardware configuration of the drive assist formulation apparatus described in the embodiments 2 to 6.

Each embodiment can be arbitrarily combined, or each embodiment can be appropriately varied or omitted within the scope of the invention.

Although the present disclosure is described in detail, the foregoing description is in all aspects illustrative and does not restrict the disclosure. It is therefore understood that numerous modification examples can be devised.

### EXPLANATION OF REFERENCE SIGNS

1 Drive assist formulation apparatus, 2 normal-accuracy node information acquisition unit, 3 high-accuracy map acquisition unit, 4 association determination unit, 5 travel determination unit, 6 drive assist formulation unit, 7 in-vehicle apparatus, 8 information processing apparatus, 9 drive assist formulation apparatus, 10 drive assist apparatus, 11 positioning apparatus, 12 normal-accuracy map DB, 13 application execution unit, 14 high-accuracy map DB, 15 association information table, 16 in-vehicle apparatus, 17 drive assist formulation apparatus, 18 in-vehicle apparatus, 19 drive assist formulation apparatus, 20 high-accuracy positioning unit, 21 processing circuit, 22 processor, 23 memory.

1.-24. (canceled)

25. A drive assist formulation apparatus, comprising:
a processor to execute a program, and
a memory to store the program which, when executed by the processor, performs processes of,
acquiring at least one piece of normal-accuracy node information including normal-accuracy positional information indicating a normal-accuracy position of a normal-accuracy node in a travel route of a subject vehicle calculated using a normal-accuracy map including road shape information and the normal-accuracy node per unit road;
acquiring a high-accuracy map including road shape information, a high-accuracy node, and a high-accuracy link per unit traffic lane;
determining whether or not the normal-accuracy position is associated with the high-accuracy node or the high-accuracy link based on the normal-accuracy node information which has been acquired and association information indicating a correspondence relationship between the normal-accuracy map and the high-accuracy map;
determining whether or not the subject vehicle travels a high-accuracy map road included in the high-accuracy map based on a determination result of the determination whether or not the normal-accuracy position is associated with the high-accuracy node or the high-accuracy link; and
formulating a drive assist of the subject vehicle using the high-accuracy map when it is determined that the subject vehicle travels the high-accuracy map road.

26. The drive assist formulation apparatus according to claim 25, wherein
the association information includes association positional information indicating a position corresponding to a position of the high-accuracy node which is specific or the high-accuracy link which is specific and association reference information which is information for referring to the high-accuracy node or the high-accuracy link included in the high-accuracy map based on the association positional information.

27. The drive assist formulation apparatus according to claim 26, wherein
the association positional information includes information indicating a predetermined area including a position corresponding to a position of the high-accuracy node which is specific or a position of the high-accuracy link which is specific.

28. The drive assist formulation apparatus according to claim 26, wherein
the normal-accuracy node information includes normal-accuracy azimuth information indicating an azimuth of the normal-accuracy link entering or exiting from the normal-accuracy node,
the association information includes association azimuth information indicating an azimuth of the high-accuracy link entering or exiting from the high-accuracy node, and
the determination whether or not the normal-accuracy position is associated with the high-accuracy node or the high-accuracy link includes a determination whether or not the normal-accuracy position is associated with the high-accuracy node or the high-accuracy link based on a first association determination determining whether or not the normal-accuracy positional information and the association positional information are associated with each other and a second association determination determining whether or not the normal-accuracy azimuth information and the association azimuth information are associated with each other.

29. The drive assist formulation apparatus according to claim 28, wherein
the association azimuth information is information indicating a predetermined azimuth range including an azimuth of the high-accuracy link entering or exiting from the high-accuracy node.

30. The drive assist formulation apparatus according to claim 28, wherein
the normal-accuracy azimuth information includes an azimuth of the normal-accuracy link entering or exiting from the normal-accuracy node, and
the association azimuth information includes an azimuth of the high-accuracy link entering or exiting from the high-accuracy node.

31. The drive assist formulation apparatus according to claim 26, wherein
the normal-accuracy node information includes a normal-accuracy link attribute indicating an attribute of a normal-accuracy link entering or exiting from the normal-accuracy node,
the association information includes an association link attribute indicating an attribute of the high-accuracy link entering or exiting from the high-accuracy node, and
the determination whether or not the normal-accuracy position is associated with the high-accuracy node or the high-accuracy link includes a determination whether or not the normal-accuracy position is associated with the high-accuracy node or the high-accuracy link based on a third association determination determining whether or not the normal-accuracy positional information and the association positional information are associated with each other and a fourth association determination determining whether or not the normal-accuracy link attribute and the association link attribute are associated with each other.

32. The drive assist formulation apparatus according to claim 31, wherein
the normal-accuracy link attribute includes an attribute of the normal-accuracy link entering or exiting from the normal-accuracy node corresponding to a junction or a branch point of a road, and
the association link attribute includes an attribute of the high-accuracy link entering or exiting from the high-accuracy node corresponding to a junction or a branch point of a road.

33. The drive assist formulation apparatus according to claim 26, wherein
the normal-accuracy node information includes normal-accuracy azimuth information indicating a normal-accuracy link entering or exiting from the normal-accuracy node and a normal-accuracy link attribute indicating an attribute of the normal-accuracy link entering or exiting from the normal-accuracy node,
the association information includes association azimuth information indicating an azimuth of the high-accuracy link entering or exiting from the high-accuracy node and an association link attribute indicating an attribute of the high-accuracy link entering or exiting from the high-accuracy node, and
the determination whether or not the normal-accuracy position is associated with the high-accuracy node or the high-accuracy link includes a determination whether or not the normal-accuracy position is associated with the high-accuracy node or the high-accuracy link based on a fifth association determination determining whether or not the normal-accuracy positional information and the association positional information are associated with each other, a sixth association determination determining whether or not the normal-accuracy azimuth information and the association azimuth information are associated with each other, and a seventh association determination determining whether or not the normal-accuracy link attribute and the association link attribute are associated with each other.

34. The drive assist formulation apparatus according to claim 33, wherein
the association link attribute includes a total number of links of the high-accuracy link entering or exiting from the high-accuracy node, and
the association information are provided in accordance with the total number of links.

35. The drive assist formulation apparatus according to claim 26, wherein
the association positional information is included as an attribute of the high-accuracy node or an attribute of the high-accuracy link corresponding to the normal-accuracy position of the normal-accuracy node.

36. The drive assist formulation apparatus according to claim 28, wherein
the association positional information and the association azimuth information are included as an attribute of the high-accuracy node or an attribute of the high-accuracy link corresponding to the normal-accuracy position of the normal-accuracy node.

37. The drive assist formulation apparatus according to claim 31, wherein
the association positional information and the association link attribute are included as an attribute of the high-accuracy node or an attribute of the high-accuracy link corresponding to the normal-accuracy position of the normal-accuracy node.

38. The drive assist formulation apparatus according to claim 25, wherein
the association information is stored in a storage medium different from the high-accuracy map.

39. The drive assist formulation apparatus according to claim 25, wherein
the formulation of the drive assist includes a formulation of a travel route per unit traffic lane which the subject vehicle travels using the high-accuracy map including the high-accuracy node or the high-accuracy link associated with the normal-accuracy position.

40. The drive assist formulation apparatus according to claim 25, wherein
the acquisition of the at least one piece of normal-accuracy node information includes acquiring the plural pieces of normal-accuracy node information satisfying a predetermined condition, and
the determination whether or not the normal-accuracy position is associated with the high-accuracy node or the high-accuracy link includes a determination whether or not each the normal-accuracy position is associated with the high-accuracy node or the high-accuracy link based on each piece of the normal-accuracy node information and the association information.

41. The drive assist formulation apparatus according to claim 25, wherein
the normal-accuracy node includes at least one entry node connected to a normal-accuracy link entering another road and at least one exit node connected to a normal-accuracy link exiting from another road.

42. The drive assist formulation apparatus according to claim 41, wherein
when a positional relationship between one of the entry nodes or one of the exit nodes and the another one of the entry nodes or the another one of the exit nodes adjacent to the one of the entry nodes or the one of the exit nodes satisfies a predetermined condition, the normal-accuracy node information includes information regarding an intermediate node set between the one of the entry nodes or the one of the exit nodes and the another one of the entry nodes or the another one of the exit nodes.

43. The drive assist formulation apparatus according to claim 25, further comprising
positioning a position of the subject vehicle per unit traffic lane, wherein
the formulation of the drive assist includes a formulation of a drive assist of the subject vehicle based on a position of the subject vehicle positioned per unit traffic lane.

44. A drive assist formulation method, comprising:
acquiring normal-accuracy node information including normal-accuracy positional information indicating a normal-accuracy position of a normal-accuracy node in a travel route of a subject vehicle calculated using a normal-accuracy map including road shape information and the normal-accuracy node per unit road;
acquiring a high-accuracy map including road shape information, a high-accuracy node, and a high-accuracy link per unit traffic lane;
determining whether or not the normal-accuracy position is associated with the high-accuracy node or the high-accuracy link based on the normal-accuracy node information which has been acquired and association information indicating a correspondence relationship between the normal-accuracy map and the high-accuracy map;
determining whether or not the subject vehicle travels a high-accuracy map road included in the high-accuracy map based on a determination result whether or not the normal-accuracy position is associated with the high-accuracy node or the high-accuracy link; and
formulating a drive assist of the subject vehicle using the high-accuracy map when it is determined that the subject vehicle travels the high-accuracy map road.
